(19) United States
(12) Patent Application Publication
(10) Pub. No.: US 2026/0267509 A1
(43) Pub. Date: Sep. 10, 2026

(54) MEMORY SYSTEM AND INFORMATION PROCESSING SYSTEM

(71) Applicant: Kioxia Corporation, Minato-ku, Tokyo (JP)

(72) Inventor: Kazusa TOMONAGA, Suginami Tokyo (JP)

(73) Assignee: Kioxia Corporation, Minato-ku, Tokyo (JP)

(21) Appl. No.: 19/237,231

(22) Filed: Jun. 13, 2025

(30) Foreign Application Priority Data
Mar. 10, 2025 (JP) 2025-037369

(51) Int. Cl. G06F 3/06

(52) U.S. Cl. CPC G06F 3/061; G06F 3/0659; G06F 3/0679

(57) ABSTRACT

According to one embodiment, a memory system is connectable to a host. The memory system includes a nonvolatile memory and a controller. The controller sets a first target value for a first indicator related to performance of the memory system. The controller measures the first indicator in a process performed in accordance with a first command received from the host to acquire a first measured value that indicates the measured first indicator. The controller acquires a delay for realizing the first target value, by using the first measured value. The controller transmits a response to a second command received from the host, to the host with the delay.

### CROSS-REFERENCE TO RELATED APPLICATIONS

This application is based upon and claims the benefit of priority from Japanese Patent Application No. 2025-037369, filed Mar. 10, 2025, the entire contents of which are incorporated herein by reference.

### FIELD

Embodiments described herein relate generally to a technique for controlling a nonvolatile memory.

### BACKGROUND

In recent years, memory systems that include a nonvolatile memory have been widely used. As one of such memory systems, a solid state drive (SSD) that includes a NAND flash memory is known. The SSD is used as a main storage of a host that is one of various computing devices.

The memory system desirably has performance that can maximize performance of an application in the host. However, the memory system with higher performance is generally expensive and consumes a large amount of power. Therefore, the memory system with excessively high performance for the application in the host is inefficient from the viewpoint of economic cost and energy.

### BRIEF DESCRIPTION OF THE DRAWINGS

FIG. 1 is a block diagram illustrating an example of a configuration of an information processing system that includes a memory system according to an embodiment.

FIG. 2 is a diagram illustrating an example of an optimized performance value of the memory system according to the embodiment.

FIG. 3 is a diagram illustrating an example of a performance control operation in a host and the memory system according to the embodiment.

FIG. 4 is a diagram illustrating an example of a read operation with a slow path in the memory system according to the embodiment.

FIG. 5 is a diagram illustrating an example of a write operation with the slow path in the memory system according to the embodiment.

FIG. 6 is a diagram illustrating an example of a read operation with a fast path in the memory system according to the embodiment.

FIG. 7 is a diagram illustrating an example of a write operation with the fast path in the memory system according to the embodiment.

FIG. 8 is a diagram illustrating an example of response times for commands in the memory system according to the embodiment.

FIG. 9 is a flowchart illustrating an example of the procedure of an optimized performance determination process executed in the host connected to the memory system according to the embodiment.

FIG. 10 is a flowchart illustrating an example of the procedure of a first delay calculation process executed in the host connected to the memory system according to the embodiment.

FIG. 11 is a flowchart illustrating an example of the procedure of a second delay calculation process executed in the host connected to the memory system according to the embodiment.

FIG. 12 is a flowchart illustrating an example of the procedure of an input/output (I/O) control process executed in the memory system according to the embodiment.

FIG. 13 is a flowchart illustrating an example of the procedure of a first command process executed in the memory system according to the embodiment.

FIG. 14 is a flowchart illustrating an example of the procedure of a second command process executed in the memory system according to the embodiment.

FIG. 15 is a flowchart illustrating an example of the procedure of a third command process executed in the memory system according to the embodiment.

FIG. 16 is a diagram illustrating another example of the performance control operation in the memory system and the host according to the embodiment.

FIG. 17 is a flowchart illustrating an example of the procedure of an optimized performance determination process executed in the memory system according to the embodiment.

### DETAILED DESCRIPTION

In general, according to one embodiment, a memory system is connectable to a host. The memory system includes a nonvolatile memory and a controller. The controller is electrically connected to the nonvolatile memory. The controller is configured to set a first target value for a first indicator that is related to performance of the memory system. The controller is further configured to receive a first command from the host, and in accordance with the received first command, perform a first process. The controller is further configured to, in the first process, measure the first indicator to acquire a first measured value that indicates the measured first indicator. The controller is further configured to acquire a delay for realizing the first target value, by using the first measured value. The controller is further configured to receive a second command from the host, and transmit, to the host, a response to the second command with the delay.

Various embodiments will be described hereinafter with reference to the accompanying drawings.

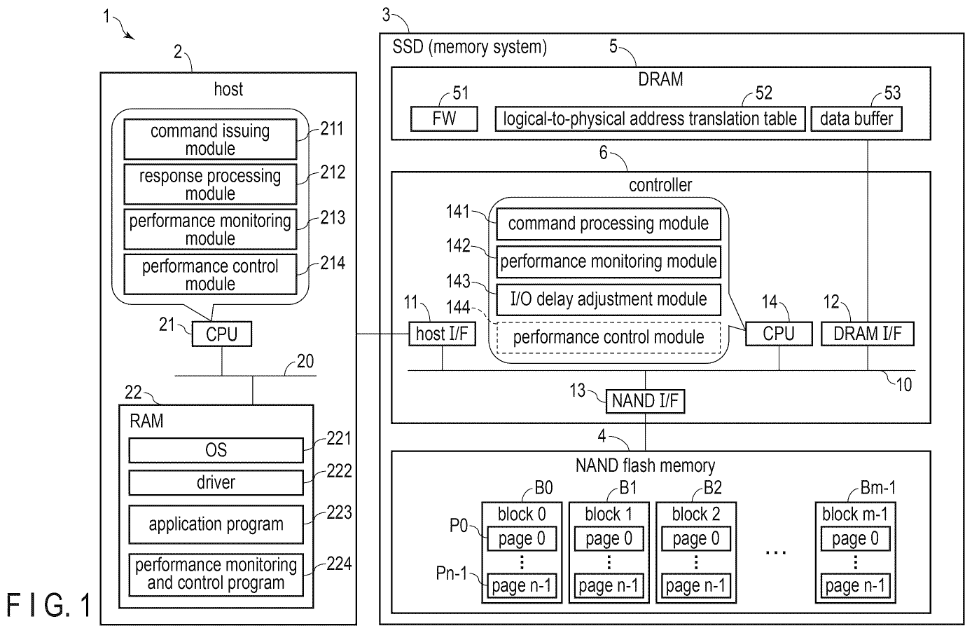

First, an example of a configuration of an information processing system 1 that includes a memory system according to an embodiment will be described with reference to FIG. 1. The information processing system 1 includes, for example, a host device 2 and a memory system 3.

The host device 2 may be a storage server that stores a large amount of various data in the memory system 3, or may be a personal computer. Hereinafter, the host device 2 is also referred to as a host 2.

The memory system 3 is a storage device configured to write data into a nonvolatile memory and read data from the nonvolatile memory. The memory system 3 is also referred to as a storage device. The nonvolatile memory is, for example, a NAND flash memory 4. The memory system 3 is implemented as, for example, a solid state drive (SSD) including the NAND flash memory 4. Hereinafter, a case where the memory system 3 is implemented as an SSD 3 including the NAND flash memory 4 will be mainly explained as an example.

The SSD 3 may be used as a storage of the host 2. The SSD 3 may be provided inside the host 2 or may be connected to the host 2 via a cable or a network.

An interface for connecting the host 2 and the SSD 3 conforms to standards such as PCI Express™ (PCIe™), Ethernet™, Fibre channel, and NVM Express™ (NVMe™).

The SSD 3 has, for example, sufficiently high performance that does not become a bottleneck of a process in the host 2. In addition, the SSD 3 is dynamically configurable the performance provided to the host 2. That is, the SSD 3 is a performance-variable SSD.

### Configuration Example of Host 2

The host 2 includes, for example, a central processing unit (CPU) 21 and a random access memory (RAM) 22. The CPU 21 and the RAM 22 are connected via, for example, a bus 20.

The CPU 21 is, for example, at least one processor. The CPU 21 controls operations of various components of the host 2.

The RAM 22 is, for example, a volatile memory. The RAM 22 is, for example, a dynamic random access memory (DRAM) or a static random access memory (SRAM). A storage area of the RAM 22 is allocated as, for example, storage areas of an operating system (OS) 221, a driver 222, an application program 223, and a performance monitoring and control program 224. The programs stored in the RAM 22 are executed by the CPU 21.

The OS 221 is a program for controlling basic operations of the various components of the host 2. The CPU 21 executing the OS 221 controls, for example, input/output, file management, memory management, and communication.

The driver 222 is a program for controlling a device connected to the host 2. For example, the CPU 21 executing the driver 222 is configured to transmit a command and data to the SSD 3 and receive data and a response to a command from the SSD 3. The command is, for example, an input/output (I/O) command or a control command. The I/O command is, for example, a write command or a read command. The control command is, for example, a trim command (also referred to as an unmap command or a deallocate command). The trim command is a command that requests invalidation of data corresponding to a designated logical address (or logical address range). The logical address is an address used by the host 2 for addressing a storage area of the SSD 3. The logical address is, for example, a logical block address (LBA).

The application program 223 is a program for realizing an application in the host 2 in cooperation with the OS 221 and the driver 222. The application is any operation (processing task) that is realized on the host 2 and uses the SSD 3. Specifically, the application is, for example, database management using the SSD 3 as a storage destination of data. The CPU 21 executes, for example, the OS 221, the driver 222, and the application program 223, thereby performing a process corresponding to the application (hereinafter, also referred to as an application process). The application process includes a process related to access to the SSD 3 (more specifically, the NAND flash memory 4). The access to the SSD 3 includes, for example, the writing of user data, the reading of user data, and the trimming (invalidation) of user data. The user data is data to be written into the NAND flash memory 4 and associated with a write command for the SSD 3.

The performance monitoring and control program 224 is a program for monitoring the performance of the host 2 related to the application and controlling the performance of the SSD 3. The performance monitoring and control program 224 may further be a program for controlling a workload for the SSD 3 in the application process. The performance monitoring and control program 224 may be a part of any of the OS 221, the driver 222, and the application program 223.

The CPU 21 functions as, for example, a command issuing module 211, a response processing module 212, a performance monitoring module 213, and a performance control module 214. The CPU 21 functions as these modules, for example, by executing the OS 221, the driver 222, the application program 223, and the performance monitoring and control program 224.

When access to the SSD 3 is requested, the command issuing module 211 issues, to the SSD 3, one or more commands corresponding to the request.

The response processing module 212 executes a process in accordance with a response (completion) from the SSD 3 to the issued command.

The performance monitoring module 213 monitors the performance of the host 2 related to the application in real time. The performance of the host 2 related to the application is also referred to as an application performance.

The application performance is the performance of the host 2 during execution of the application process. The application performance is represented by an indicator indicative of the performance of the host 2 related to the application (hereinafter, referred to as a host performance indicator). As the host performance indicator, a certain indicator appropriate for the application is used. For example, in a case where the application is database management, the host performance indicator is transaction per second (TPS). The TPS indicates the number of transactions processed per second.

The performance monitoring module 213 measures the host performance indicator during the execution of the application process, thereby acquiring a measured value indicative of the measured host performance indicator (hereinafter, also referred to as a measured application performance value). The performance monitoring module 213 sends the measured application performance value to the performance control module 214.

The performance control module 214 controls the performance of the SSD 3. The performance of the SSD 3 may be also simply referred to as an SSD performance.

The SSD performance is represented by one or more indicators that are related to the performance of the SSD 3. Hereinafter, these one or more indicators are referred to as SSD performance indicators. The one or more SSD performance indicators include, for example, at least one of input/output operations per second (IOPS), a bandwidth, a latency, and a tail latency. Generally speaking, the SSD performance indicators are one or more indicators related to an execution speed of a command received from the host 2. The SSD performance indicators are one or more indicators that may be related to the application performance of the host 2 (for example, may vary the application performance). Each of the SSD performance indicators may be an indicator whose performance value may be evaluated and dynamically controlled (changed) on the basis of performance to be provided from the SSD 3 to the host 2.

The IOPS indicate the number of I/O commands processed per second. The size of data input or output (that is, read or written) according to one I/O command is, for example, 4 KB.

The bandwidth indicates the amount of data input and output per unit time. The unit time is, for example, one second. In this case, the bandwidth is a value obtained by multiplying the size of data input/output according to one I/O command by the IOPS.

The latency indicates a response time for a command.

The tail latency indicates a response time that becomes extremely long relative to an average value of response times (latencies) for commands. More specifically, a tail latency of P % indicates that response times for P % of commands are equal to or shorter than the tail latency and response times for the remaining (100-P) % of the commands exceed the tail latency. That is, P % indicates a ratio of commands for which the response times are not outliers. For example, 99%, 99.9%, or 99.99% is used as P %.

The SSD performance indicators may be evaluated (for example, set or measured) for each type of access. Examples of the type of access include read, write, and trim. Therefore, various indicators such as IOPS for read, IOPS for write, a bandwidth for read, a bandwidth for write, a latency for read, a latency for write, a latency for trim, and a tail latency of 99.9% may be used as the SSD performance indicators. Note that as the SSD performance indicators, any indicator indicative of the performance of the SSD 3, which is not limited to the indicators described above, may be used.

The performance control module 214 selects the one or more SSD performance indicators according to, for example, characteristics of the application in the host 2 (for example, an assumed workload). Alternatively, the one or more SSD performance indicators may be empirically selected by a user.

For example, the performance control module 214 determines one or more target values that correspond to the one or more SSD performance indicators, respectively (hereinafter, also referred to as target performance values). The performance control module 214 transmits the determined one or more target performance values to the SSD 3.

The performance control module 214 receives one or more measured values that correspond to the one or more SSD performance indicators, respectively (hereinafter, also referred to as measured SSD performance values), from the SSD 3. The performance control module 214 dynamically calculates (determines) a delay for realizing the one or more target performance values by using the one or more measured SSD performance values. The delay is a time for which a response to a command from the host 2 is delayed (that is, a response delay) in the SSD 3. The performance control module 214 transmits the calculated delay to the SSD 3. In the SSD 3, an operation of transmitting a response to a command with the transmitted delay is performed. As a result, the one or more target performance values may be realized (achieved) in the SSD 3. A specific method of calculating the delay will be described below.

In addition, the performance control module 214 determines, by using a plurality of measured application performance values received from the performance monitoring module 213, one or more performance values that are optimized for the application and correspond to the one or more SSD performance indicators, respectively. Hereinafter, the determined one or more performance values are also referred to as optimized performance values. Each of the measured application performance values is obtained, for example, while different target performance values are set for the SSD 3. The performance control module 214 determines a saturation point of the application performance with respect to the performance of the SSD 3 by using the measured application performance values. The performance control module 214 determines the performance of the SSD 3 corresponding to the determined saturation point of the application performance (that is, the target performance values when the saturation point was obtained), as the optimized performance value of the SSD 3.

Note that the performance control module 214 may control a workload for the SSD 3 in the application process. Alternatively, the workload may be set empirically by the user.

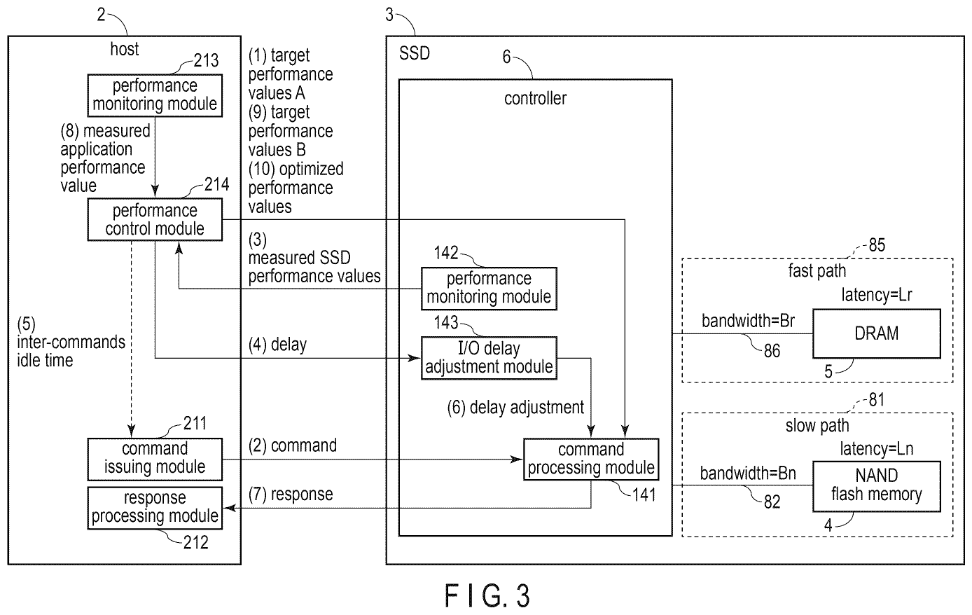

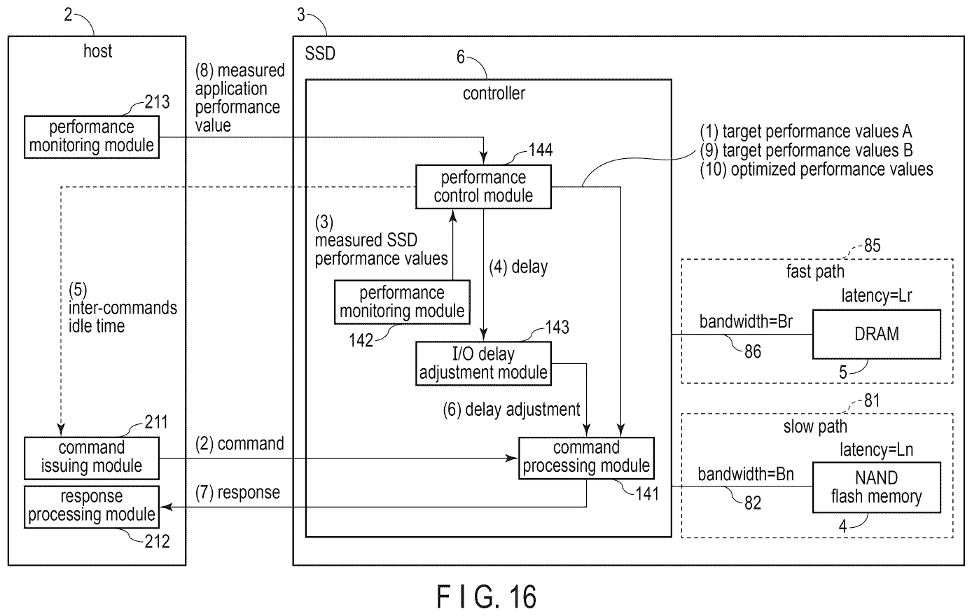

Examples of a specific operation of the command issuing module 211, the response processing module 212, the performance monitoring module 213, and the performance control module 214 are described below with reference to FIGS. 3 and 16.

### Configuration Example of SSD 3

The SSD 3 includes, for example, the NAND flash memory 4, a DRAM 5, and a controller 6.

The NAND flash memory 4 includes a plurality of blocks (blocks B0, B1, B2, . . . , and Bm-1). The plurality of blocks each function as a minimum unit of a data erase operation. The block is also referred to as an erase block or a physical block. Each of the plurality of blocks includes a plurality of pages (pages P0, . . . , and Pn-1). Each of the plurality of pages includes a plurality of memory cells connected to a single word line. The plurality of pages each function as a unit of a data write operation and a data read operation. Note that a word line may also function as a unit of a data write operation and a data read operation.

The tolerable maximum number of program/erase cycles (maximum number of P/E cycles) for each of the plurality of blocks is limited. One P/E cycle of a block includes a data erase operation to erase data stored in all memory cells of the block and a data program operation to write data in each page of the block.

The DRAM 5 is a volatile memory. A storage area of the DRAM 5 is allocated as, for example, a storage area of firmware (FW) 51, a cache area of a logical-to-physical address translation table 52, and a data buffer 53.

The FW 51 is a program for controlling an operation of the controller 6. The FW 51 is loaded from the NAND flash memory 4 to the DRAM 5, for example.

The logical-to-physical address translation table 52 is a table for managing mapping between each logical address and each physical address of the NAND flash memory 4. The logical-to-physical address translation table 52 may be loaded from the NAND flash memory 4 to the DRAM 5 when the SSD 3 is boot up.

The data buffer 53 is a buffer area for temporarily storing user data. The user data stored in the data buffer 53 is, for example, user data to be written into the NAND flash memory 4 or user data read from the NAND flash memory 4.

The controller 6 may be implemented with a circuit such as a system-on-a-chip (SoC). The controller 6 may be implemented with a plurality of semiconductor chips. The controller 6 is electrically connected to the NAND flash memory 4 and is configured to control the NAND flash memory 4. The function of each unit of the controller 6 may be realized by dedicated hardware in the controller 6 or may be realized by a processor executing the FW 51.

The controller 6 may function as a flash translation layer (FTL) configured to execute data management and block management of the NAND flash memory 4. The data management performed by the FTL includes (1) management of mapping data indicative of a relationship between each logical address and each physical address of the NAND flash memory 4, and (2) a process to hide a difference between data read/write operations in units of page and data erase operations in units of block. The block management includes management of defective blocks, wear-leveling, and garbage collection (GC).

The management of mapping between each logical address and each physical address is executed by using, for example, the logical-to-physical address translation table 52. The controller 6 uses the logical-to-physical address translation table 52 to manage mapping between each logical address and each physical address in a certain management size. A physical address corresponding to a logical address indicates a physical memory location in the NAND flash memory 4 to which data of the logical address has been written. The controller 6 manages, by using the logical-to-physical address translation table 52, a plurality of storage areas that are obtained by logically dividing the storage area of the NAND flash memory 4. The size of each of the plurality of storage areas is the management size described above. The plurality of storage areas correspond to a plurality of logical addresses, respectively. That is, each of the plurality of storage areas is identified by one logical address.

The data write operation into one page is executable only once in a single P/E cycle. Thus, the controller 6 writes updated data corresponding to a logical address not to an original physical memory location in which previous data corresponding to the logical address is stored but to a different physical memory location. Then, the controller 6 updates the logical-to-physical address translation table 52 to associate the logical address with this different physical memory location rather than the original physical memory location and to invalidate the previous data (i.e., data stored in the original physical memory location). Data to which the logical-to-physical address translation table 52 refers (that is, data associated with a logical address) is valid data. Furthermore, data not associated with any logical address is invalid data.

The controller 6 includes, for example, a host interface circuit (host I/F) 11, a DRAM interface circuit (DRAM I/F) 12, a NAND interface circuit (NAND I/F) 13, and a CPU 14. The host I/F 11, the DRAM I/F 12, the NAND I/F 13, and the CPU 14 are connected via, for example, a bus 10. The controller 6 may further include an SRAM. The SRAM is a volatile memory. The SRAM is connected to each unit of the controller 6 via, for example, the bus 10. The SRAM may store at least a part of the data stored in the DRAM 5 described above.

The host I/F 11 is a circuit configured to receive various commands and data from the host 2 and transmit data and a response to a command to the host 2.

The DRAM I/F 12 is a DRAM control circuit configured to control access to the DRAM 5. The DRAM I/F 12 electrically connects the controller 6 and the DRAM 5. The DRAM I/F 12 conforms to a standard such as a double data rate (DDR).

The NAND I/F 13 is a NAND control circuit configured to control the NAND flash memory 4. The NAND I/F 13 may be connected to a plurality of memory chips in the NAND flash memory 4 via a plurality of channels. By operating the plurality of memory chips in parallel, it is possible to broaden an access bandwidth between the controller 6 and the NAND flash memory 4.

The NAND I/F 13 conforms to an interface standard such as a toggle DDR and an open NAND flash interface (ONFI).

The CPU 14 is a processor configured to control the host I/F 11, the DRAM I/F 12, and the NAND I/F 13. The CPU 14 executes various processes by executing the FW 51 loaded from the NAND flash memory 4 to the DRAM 5. The FW 51 is a control program including instructions for causing the CPU 14 to execute the various processes. The CPU 14 may perform command processes to execute various commands from the host 2. The operation of the CPU 14 is controlled by the FW 51 executed by the CPU 14.

The CPU 14 functions as, for example, a command processing module 141, a performance monitoring module 142, and an I/O delay adjustment module 143. The CPU 14 functions as these modules, for example, by executing the FW 51.

The command processing module 141 executes a process in accordance with a command received from the host 2 via the host I/F 11, based on the one or more target performance values set for the SSD 3. The command processing module 141 receives the one or more target performance values from the host 2, for example. The command processing module 141 sets the received one or more target performance values as current target performance values of the SSD 3. As the process in accordance with the received command, the command processing module 141 executes any one or both of a process for the NAND flash memory 4 via the NAND I/F 13 and a process for the DRAM 5 via the DRAM I/F 12.

The performance monitoring module 142 monitors, in real time, the SSD performance during the execution of the process in accordance with the command. Specifically, the performance monitoring module 142 measures the one or more SSD performance indicators during the execution of the process in accordance with the command, thereby acquiring one or more measured values (i.e., the measured SSD performance values described above) that indicate the measured one or more SSD performance indicators, respectively. The performance monitoring module 213 transmits the one or more measured SSD performance values to the host 2 via the host I/F 11, for example.

The I/O delay adjustment module 143 acquires a delay and performs control so that a response to a command is transmitted to the host 2 with the delay. Specifically, the I/O delay adjustment module 143 receives the delay from the host 2 via the host I/F 11, for example. The I/O delay adjustment module 143 inserts the delay into a response time in a process of the command executed by the command processing module 141. For example, the I/O delay adjustment module 143 inserts the delay for each command, thereby adjusting the response time. As a result, in the SSD 3, an operation with the target performance values that are currently set is realized.

The CPU 14 may further function as a performance control module 144. The performance control module 144 has at least a part of the functions of the performance control module 214 of the host 2 described above (for example, at least any one of the function of determining the target performance values, the function of calculating the delay, and the function of determining the optimized performance values).

Specific operations of the command processing module 141, the performance monitoring module 142, the I/O delay adjustment module 143, and the performance control module 144 will be described below with reference to FIGS. 3 to 7 and 16.

Here, a relationship between the application performance and the SSD performance will be described.

An SSD desirably has performance that can maximize the application performance. In order to determine such performance of the SSD, it is necessary to determine whether or not a bottleneck of the application performance is caused by either the performance of the SSD or the performance of a host. In a case where the bottleneck of the application performance is caused by the performance of the host, enhancing the performance of the SSD does not improve the application performance. Therefore, the enhanced performance of the SSD is an excessive (overengineered) performance.

The SSD with higher performance is generally expensive and consumes a large amount of power. Therefore, the SSD with excessively high performance for an application in the host is inefficient from the viewpoint of economic cost and energy.

The performance of the SSD is usually fixed. Therefore, in order to determine whether or not the application performance is improved through enhancing the performance of the SSD, for example, it is necessary to replace the SSD connected to the host with an SSD having higher performance. In addition, in order to determine whether or not the application performance is degraded through degrading the performance of the SSD, for example, it is necessary to replace the SSD connected to the host with an SSD having lower performance. It is cumbersome and generally difficult to use a plurality of SSDs having different performances for determining a correlation between the SSD performance and the application performance.

In contrast, the information processing system 1 according to the present embodiment is configured to change values of various performance indicators of the SSD 3 and provide the host 2 with performance based on the changed values. Specifically, for example, the controller 6 of the SSD 3 controls a command process for executing a command from the host 2 and responding to the command so as to realize target performance values that are currently set. In the command process, for example, the controller 6 dynamically adjusts a delay inserted into a response time, thereby realizing the target performance values. The information processing system 1 according to the present embodiment operates the SSD 3 with certain target performance values (for example, target performance values suitable for the application), and thus can prevent the SSD 3 from operating with excessively high performance.

In addition, the controller 6 finds the saturation point of the application performance with respect to the SSD performance through changing values of the various performance indicators (i.e., target performance values) of the SSD 3. Then, the controller 6 identifies values of the various performance indicators of the SSD 3 that correspond to the saturation point of the application performance, as performance values of the SSD 3 optimized for the application in the host 2 (i.e., optimized performance values). The optimized performance values indicate a specification of the SSD 3 having minimum performance (i.e., lowest specification of the SSD 3) that maximizes the application performance.

The power consumption of the SSD 3 can be reduced by operating the SSD 3 at the optimized performance lower than the maximum performance. In other words, the SSD 3 can optimize energy efficiency for the application in the host 2.

Furthermore, by identifying the optimized performance, an SSD vendor and a customer that operates the application in the host 2 can recognize a model or a setting of an SSD suitable for the application. Therefore, the vendor can propose, for example, an SSD of a model having the optimized performance as an SSD to be connected to the host 2. In addition, the customer can select, for example, an SSD suitable for the application.

SSDs have been widely used as storage devices that provide high-speed I/O performance. However, in an enterprise environment or a cloud environment, the maximum performance of an SSD often exceeds requirements of the entire system, and thus economic cost efficiency decreases. In addition, for example, either with a statically set (i.e., fixed) performance of an SSD, or with dynamic performance adjustment (or I/O scheduling) for a quality of service (QoS), it is not possible to guarantee the minimum performance while preventing the excessive performance.

In the information processing system 1 of the present embodiment, the cost efficiency and the energy efficiency can be optimized for the application through the control for operating the SSD 3 with certain performance and the determination of the optimized performance. As a result, it is possible to reduce economic resources, energy resources, and global environmental burden.

Note that at least a part of the process of the control for operating the SSD 3 with certain performance and the determination of the optimized performance may be performed in the host 2.

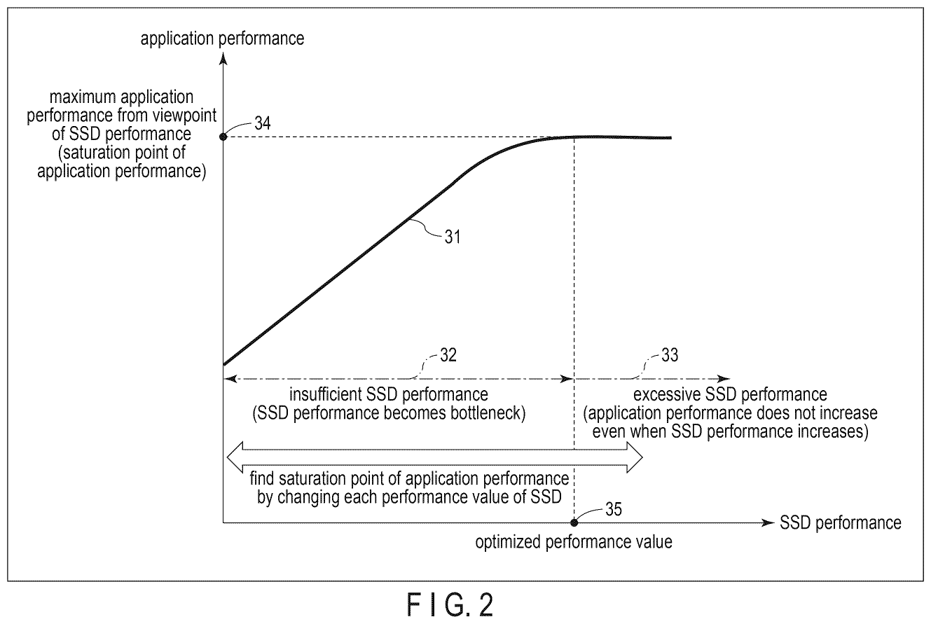

FIG. 2 illustrates an example of the optimized performance value of the SSD 3 that is determined based on the correlation between the SSD performance and the application performance. In a graph 31 illustrated in FIG. 2, the horizontal axis represents the SSD performance and the vertical axis represents the application performance.

During the SSD 3 operating with certain performance, the application performance is measured while various workloads assumed in the actual application process are processed, for example. Each workload is set, for example, in terms of the type of access and continuity of access. The type of access is, for example, write, read, trim, or any combination thereof. The continuity of access is, for example, sequential access, random access, or a combination thereof. The application performance is measured while the host 2 transmits commands according to the set workload to the SSD 3 and the SSD 3 operating with the set performance processes the commands. As a result, the correlation between the SSD performance and the application performance is modeled, for example, as in the graph 31.

The SSD performance 32 becomes the bottleneck of the application performance. That is, the SSD performance 32 is insufficient for the application. The graph 31 indicates that, the higher the SSD performance 32, the higher the application performance.

The SSD performance 33 does not become the bottleneck of the application performance. That is, the SSD performance 33 is excessive for the application. In this case, the bottleneck of the application performance is, for example, the performance of the host 2. The graph 31 indicates that the application performance does not increase even when the SSD performance 33 increases.

In the information processing system 1 according to the present embodiment, the SSD performance represented by the one or more SSD performance indicators is changed, and a saturation point 34 at which the application performance is saturated with respect to the SSD performance is found. The SSD performance 35 corresponding to the saturation point 34 is the performance of the SSD 3 optimized for the application. The SSD performance 35 corresponding to the saturation point 34 is also referred to as an optimized performance value 35. The optimized performance value 35 is the minimum performance value of the SSD 3 that can maximize the application performance.

By operating the SSD 3 with the optimized performance value 35, the power consumption can be reduced. Alternatively, by selecting an SSD having the optimized performance value 35 as an SSD to be connected to the host 2, the power consumption can be reduced and the economic cost may also be reduced. Therefore, by obtaining the optimized performance value 35, the economic cost efficiency and the energy efficiency can be optimized, and thus a reduction of economic resources, energy resources, and global environmental burden can be realized.

Next, specific operations in the host 2 and the SSD 3 will be described with reference to FIGS. 3 to 7.

FIG. 3 illustrates an example of a performance control operation in the host 2 and the SSD 3. The performance control operation is an operation for controlling the actual performance of the SSD 3 to realize the target performance values set for the SSD 3 and determining the optimized performance values of the SSD 3. Here, a case where the host 2 determines the target performance values and a delay will be described. In the SSD 3, the target performance values may be realized by transmitting a response to a command with the delay.

First, the performance control module 214 of the host 2 transmits one or more target performance values that correspond to the one or more SSD performance indicators, respectively (hereinafter, referred to as target performance values A), to the SSD 3 ((1) in FIG. 3). Specifically, the performance control module 214 determines, for example, the target performance values A estimated to be insufficient for the application in the host 2. Alternatively, the performance control module 214 may determine the target performance values A estimated to be excessive for the application in the host 2. The performance control module 214 transmits the determined target performance values A to the SSD 3.

The command processing module 141 of the SSD 3 sets the target performance values A transmitted by the host 2 as the current target performance values in the SSD 3. Performance based on the one or more target performance values is also referred to as target performance.

Next, the command issuing module 211 of the host 2 issues a command to the SSD 3 according to a workload of the application ((2) in FIG. 3). The workload is set and changed by the performance control module 214, for example.

The command processing module 141 executes a process (hereinafter, also referred to as a command execution process) of accessing any one or both of the NAND flash memory 4 and the DRAM 5 on the basis of the issued command and the current target performance values. The command execution process is, for example, a process of reading user data based on a read command or a process of writing user data based on a write command. The command execution process may be a process of updating the logical-to-physical address translation table 52 according to a trim command. In a case where a plurality of types of commands (for example, a read command and a write command) are mixed, or in a case where random access and sequential access are mixed, the command processing module 141 may execute the command execution process of accessing the NAND flash memory 4 and the command execution process of accessing the DRAM 5 in parallel. A path of access performed in the command execution process for the NAND flash memory 4 is referred to as a slow path 81. A path of access performed in the command execution process for the DRAM 5 is referred to as a fast path 85.

In the slow path 81, the NAND flash memory 4 is accessed via a communication path 82. The maximum performance of the SSD 3 in a case where the slow path 81 is used is referred to as the maximum performance of the slow path. The maximum performance of the slow path is indicated by, for example, a bandwidth Bn in a case where the slow path 81 is used and a latency Ln in a case where the slow path 81 is used.

In the fast path 85, the DRAM 5 is accessed via a communication path 86. The maximum performance of the SSD 3 in a case where the fast path 85 is used is referred to as the maximum performance of the fast path. The maximum performance of the fast path is indicated by, for example, a bandwidth Br in a case where the fast path 85 is used and a latency Lr in a case where the fast path 85 is used.

In a case where the current target performance is equal to or lower than the maximum performance of the slow path, the command processing module 141 executes the command execution process with the slow path 81. In a case where the current target performance is higher than the maximum performance of the slow path, the command processing module 141 executes the command execution process with the fast path 85.

Note that, in comparing the target performance with the maximum performance of the slow path, for example, the command processing module 141 respectively compares (A) one or more target performance values that correspond to the target performance and (B) one or more values respectively indicating one or more SSD performance indicators that correspond to the maximum performance of the slow path. Hereinafter, the one or more values are referred to as the maximum performance values of the slow path. For example, in a case where every target performance value indicates performance equal to or lower than the corresponding maximum performance value of the slow path, the command processing module 141 determines that the target performance is equal to or lower than the maximum performance of the slow path. In addition, for example, in a case where at least one of the one or more target performance values indicates performance higher than the corresponding maximum performance value of the slow path, the command processing module 141 determines that the target performance is higher than the maximum performance of the slow path. The same applies to comparison between the target performance and the maximum performance of the fast path.

The performance monitoring module 142 measures the one or more SSD performance indicators in a process in accordance with one or more commands received from the host 2. As a result, the performance monitoring module 142 acquires one or more measured values (measured SSD performance values) that indicate the measured one or more SSD performance indicators, respectively. The performance monitoring module 142 transmits the measured SSD performance values to the host 2 ((3) in FIG. 3).

The performance control module 214 of the host 2 calculates a delay on the basis of the measured SSD performance values received from the SSD 3 and the target performance values A. Then, the performance control module 214 transmits the calculated delay to the SSD 3 ((4) in FIG. 3).

Note that the performance control module 214 may calculate an inter-commands idle time on the basis of the measured SSD performance values and the target performance values A. The inter-commands idle time is, for example, a time interval from reception of a response to a command to issuance of the next command. The performance control module 214 sends the calculated inter-commands idle time to the command issuing module 211 ((5) in FIG. 3). The command issuing module 211 may control a timing when issuing a command for the SSD 3, based on the inter-commands idle time.

The I/O delay adjustment module 143 of the SSD 3 adjusts a timing at which the command processing module 141 executes an I/O completion process on the basis of the delay received from the host 2 ((6) in FIG. 3). The I/O completion process is a process of generating a response to the command and transmitting the generated response to the host 2. Specifically, for example, under control from the I/O delay adjustment module 143, the command processing module 141 starts the I/O completion process when the delay has elapsed since the command execution process was completed. The I/O delay adjustment module 143 determines the elapse of the delay by using, for example, a timer.

The command processing module 141 executes the I/O completion process according to the adjustment based on the delay by the I/O delay adjustment module 143. That is, when the delay has elapsed since the command execution process was completed, the command processing module 141 generates the response to the command and transmits the response to the host 2 ((7) in FIG. 3).

The response processing module 212 of the host 2 executes a process in accordance with the response received from the SSD 3.

The performance monitoring module 213 measures the host performance indicator while target performance based on certain target performance values (for example, the target performance values A) is set. As a result, the performance monitoring module 213 acquires a measured value indicative of the measured host performance indicator (i.e., measured application performance value). The performance monitoring module 213 sends the measured application performance value to the performance control module 214 ((8) in FIG. 3).

For example, when having received the measured application performance value from the performance monitoring module 213, the performance control module 214 transmits one or more new target performance values that correspond to the one or more SSD performance indicators, respectively (hereinafter, referred to as target performance values B), to the SSD 3 ((9) in FIG. 3). Specifically, the performance control module 214 determines, for example, the target performance values B that indicate performance higher than that of the target performance values A. Alternatively, the performance control module 214 may determine the target performance values B that indicate performance lower than that of the target performance values A. The performance control module 214 transmits the determined target performance values B to the SSD 3. As a result, the SSD 3 and the host 2 perform an operation for the target performance values B that is similar to the above-described operation in a case where the target performance values A are set.

In addition, the performance control module 214 detects the saturation point of the measured application performance value (e.g., the saturation point 34 illustrated in FIG. 2) by using a plurality of measured application performance values received from the performance monitoring module 213. The performance control module 214 determines target performance values that correspond to the detected saturation point of the measured application performance value, as the optimized performance values of the SSD 3 (e.g., the optimized performance values 35 illustrated in FIG. 2). For example, the performance control module 214 transmits the determined optimized performance values to the SSD 3 ((10) in FIG. 3). In the SSD 3, the optimized performance values may be set as the current target performance values, and an operation based on the optimized performance values may be performed.

For example, it is assumed a case where the plurality of measured application performance values include a measured application performance value A measured while the target performance based on the target performance values A is set and a measured application performance value B measured while the target performance based on the target performance values B is set, and the workload is constant while the target performance values A and the target performance values B are set. The workload is, for example, a sufficiently high workload (for example, the maximum possible workload) among workloads assumed to be required in the application process.

For example, in a case where the target performance based on the target performance values B is higher than the target performance based on the target performance values A and the measured application performance value B indicates performance equal to or lower than that of the measured application performance value A, the performance control module 214 detects the measured application performance value A as the saturation point. Alternatively, in a case where the target performance based on the target performance values B is higher than the target performance based on the target performance values A and a difference between the measured application performance value B and the measured application performance value A is smaller than a threshold, the performance control module 214 may detect the measured application performance value A as the saturation point. Then, the performance control module 214 determines the target performance values A that correspond to the measured application performance value A, as the optimized performance values of the SSD 3.

Note that, in a case where the target performance based on the target performance values B is higher than the target performance based on the target performance values A, and the measured application performance value B indicates performance higher than that of the measured application performance value A, the performance control module 214 does not detect the saturation point of the measured application performance values. That is, in a case where, in response to a change of the target performance values to values indicative of higher performance, the measured application performance value is also improved, the performance control module 214 does not detect the saturation point of the measured application performance values. In this case, in the host 2 and the SSD 3, an operation for setting different target performance values and obtaining a measured application performance value while the different target performance values are set is further performed.

Through the performance control operation described above, the host 2 determines the delay on the basis of the target performance set for the SSD 3 and the measured performance values of the SSD 3. The SSD 3 transmits the response to the command with the determined delay. As a result, the performance of the SSD 3 can be controlled so as to realize the set target performance. In addition, the host 2 can detect the saturation point of the measured application performance values by using the plurality of measured application performance values that are obtained while respective target performances are set, and determine the optimized performance values of the SSD 3.

### I/O Operation Using Slow Path 81

An I/O operation using the slow path 81 will be specifically described. The I/O operation using the slow path 81 includes a read operation and a write operation in a case where the target performance of the SSD 3 is equal to or lower than the maximum performance of the slow path. Note that, here, it is assumed that the I/O delay adjustment module 143 has already acquired a delay.

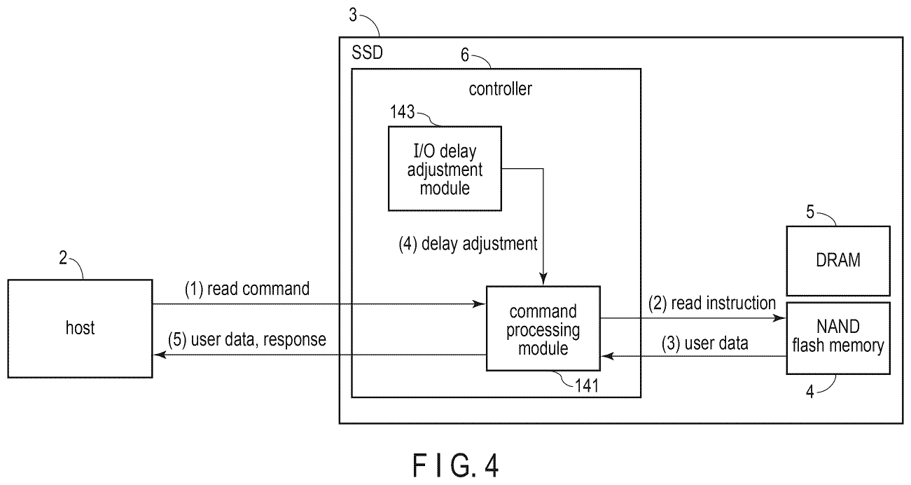

FIG. 4 illustrates an example of a read operation using the slow path 81 in the SSD 3.

First, the command processing module 141 of the SSD 3 receives a read command from the host 2 ((1) in FIG. 4). The command processing module 141 sends, to the NAND flash memory 4, an instruction to read user data (read instruction) that corresponds to the received read command ((2) in FIG. 4). Specifically, the command processing module 141 acquires a physical address associated with a logical address designated in the read command by using the logical-to-physical address translation table 52. The command processing module 141 instructs the NAND flash memory 4 to read the user data from the acquired physical address.

In the NAND flash memory 4, the user data is read in response to the read instruction ((3) in FIG. 4). The read user data may be stored in a RAM such as the DRAM 5.

The I/O delay adjustment module 143 adjusts a timing at which the command processing module 141 executes a process for responding to the read command (hereinafter, referred to as a read completion process), based on the delay ((4) in FIG. 4).

The command processing module 141 executes the read completion process according to the adjustment of the delay by the I/O delay adjustment module 143 ((5) in FIG. 4). Specifically, the command processing module 141 reads the user data from the NAND flash memory 4. The command processing module 141 transmits the read user data to the host 2. The command processing module 141 generates a response to the read command when the delay has elapsed since the transmission of the user data was completed. Then, the command processing module 141 transmits the generated response to the host 2.

Through the read operation described above, the command processing module 141 reads the user data corresponding to the read command from the NAND flash memory 4. Then, the I/O delay adjustment module 143 and the command processing module 141 transmit the response to the read command to the host 2 with the delay. As a result, in a case where the target performance of the SSD 3 is equal to or lower than the maximum performance of the slow path, the target performance (that is, the one or more target performance values) is realized as the actual performance of the SSD 3.

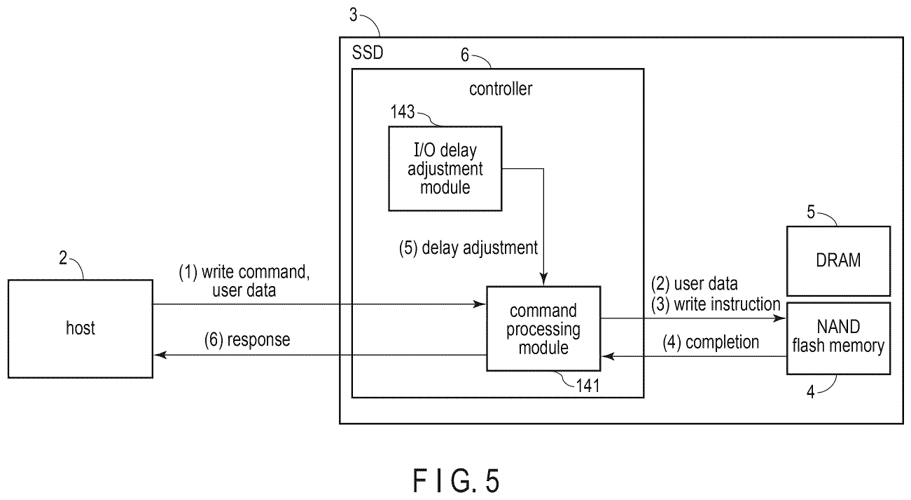

FIG. 5 illustrates an example of a write operation using the slow path 81 in the SSD 3.

First, the command processing module 141 of the SSD 3 receives, from the host 2, a write command and user data to be written in accordance with the write command ((1) in FIG. 5). The command processing module 141 transfers the received user data to the NAND flash memory 4 ((2) in FIG. 5). Then, the command processing module 141 sends an instruction to write the transferred user data (write instruction), to the NAND flash memory 4 ((3) in FIG. 5).

In the NAND flash memory 4, the user data is written in response to the write instruction, and the writing of the user data is completed ((4) in FIG. 5). For example, the command processing module 141 updates the logical-to-physical address translation table 52 to associate a logical address designated in the write command with a physical address indicative of a physical memory location where the user data has been written.

The I/O delay adjustment module 143 adjusts a timing at which the command processing module 141 executes a process for responding to the write command (hereinafter, referred to as a write completion process), based on the delay ((5) in FIG. 5).

The command processing module 141 executes the write completion process according to the adjustment of the delay by the I/O delay adjustment module 143 ((6) in FIG. 5). Specifically, the command processing module 141 generates a response to the write command when the delay has elapsed since the writing of the user data to the NAND flash memory 4 was completed. Then, the command processing module 141 transmits the generated response to the host 2.

Through the write operation described above, the command processing module 141 writes the user data to be written in accordance with the write command, into the NAND flash memory 4. Then, the I/O delay adjustment module 143 and the command processing module 141 transmit the response to the write command to the host 2 with the delay. As a result, in a case where the target performance of the SSD 3 is equal to or lower than the maximum performance of the slow path, the target performance is realized as the actual performance of the SSD 3.

### I/O Operation Using Fast Path 85

An I/O operation using the fast path 85 will be specifically described. The I/O operation using the fast path 85 includes a read operation and a write operation in a case where the target performance of the SSD 3 is equal to or lower than the maximum performance of the fast path, and a read operation and a write operation in a case where the target performance of the SSD 3 exceeds the maximum performance of the fast path. Here, it is assumed that the I/O delay adjustment module 143 has already acquired a delay.

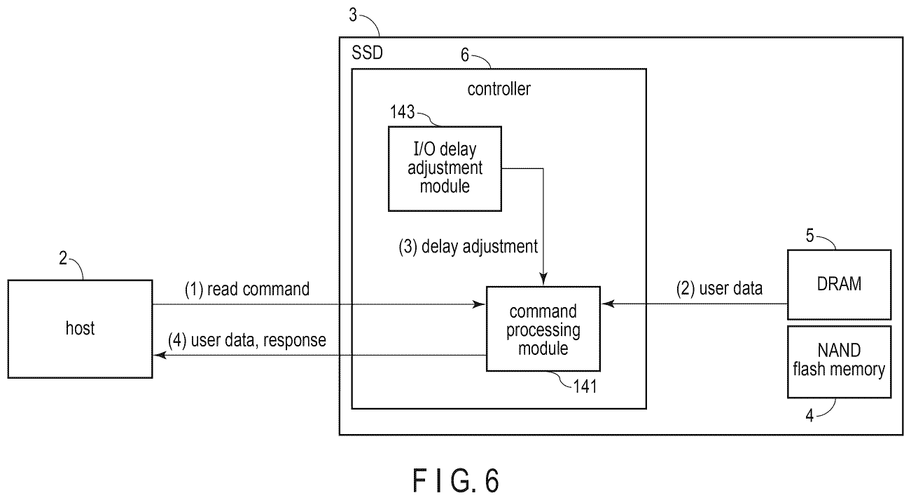

FIG. 6 illustrates an example of a read operation using the fast path 85 in the SSD 3. Here, it is assumed that user data to be read from the NAND flash memory 4 in accordance with a read command (user data corresponding to the read command) is cached in the DRAM 5. Note that, in the actual I/O operation using the fast path 85, for example, in an operation based on the optimized performance values, the user data is cached in the DRAM 5 (for example, the data buffer 53) in advance, by using any algorithm for predicting user data having a high possibility of being read. By contrast, in the case of determining the maximum performance of the fast path, that is, in the case of acquiring measured SSD performance values with use of the fast path 85, for example, information for identifying user data (for example, an LBA range) is given in advance from the host 2, and all pieces of the user data to be read are stored in advance in the DRAM 5 on the basis of the information. The methods of storing user data in the DRAM 5 in advance described herein are examples, and any method according to characteristics of the application of the host 2, the functions of the SSD 3, and the like may be used.

First, the command processing module 141 of the SSD 3 receives a read command from the host 2 ((1) in FIG. 6). The command processing module 141 reads user data corresponding to the received read command from the DRAM 5 ((2) in FIG. 6). Specifically, for example, the command processing module 141 reads the user data from a memory location in the DRAM 5 that is associated with a logical address designated in the read command.

The I/O delay adjustment module 143 adjusts a timing at which the command processing module 141 executes the read completion process, based on the delay ((3) in FIG. 6). Note that, in a case where the target performance of the SSD 3 is equal to or lower than the maximum performance of the fast path, for example, a value of zero or larger is set as the delay. In other words, in a case where the target performance of the SSD 3 is equal to or lower than the maximum performance of the fast path, the I/O delay adjustment module 143 adjusts the timing at which the command processing module 141 executes the read completion process. On the other hand, in a case where the target performance of the SSD 3 exceeds the maximum performance of the fast path, for example, zero is set as the delay. In other words, in a case where the target performance of the SSD 3 exceeds the maximum performance of the fast path, the I/O delay adjustment module 143 does not adjust the timing at which the command processing module 141 executes the read completion process.

The command processing module 141 executes the read completion process according to the adjustment based on the delay by the I/O delay adjustment module 143 ((4) in FIG. 6). Specifically, the command processing module 141 transmits the read user data to the host 2. In a case where the target performance of the SSD 3 is equal to or lower than the maximum performance of the fast path, the command processing module 141 generates a response to the read command when the delay has elapsed since the transmission of the user data was completed. In addition, in a case where the target performance of the SSD 3 exceeds the maximum performance of the fast path, the command processing module 141 generates the response to the read command when the transmission of the user data has been completed. Then, the command processing module 141 transmits the generated response to the host 2.

Through the read operation described above, the command processing module 141 reads the user data corresponding to the read command from the DRAM 5. Then, in a case where the target performance of the SSD 3 is equal to or lower than the maximum performance of the fast path, the I/O delay adjustment module 143 and the command processing module 141 transmit the response to the read command to the host 2 with the delay. As a result, in a case where the target performance of the SSD 3 is equal to or lower than the maximum performance of the fast path, the target performance is realized as the actual performance of the SSD 3.

Note that, in a case where the target performance of the SSD 3 exceeds the maximum performance of the fast path, the I/O delay adjustment module 143 and the command processing module 141 transmit the response to the read command to the host 2 without delay. In this case, the target performance is not realized as the actual performance of the SSD 3.

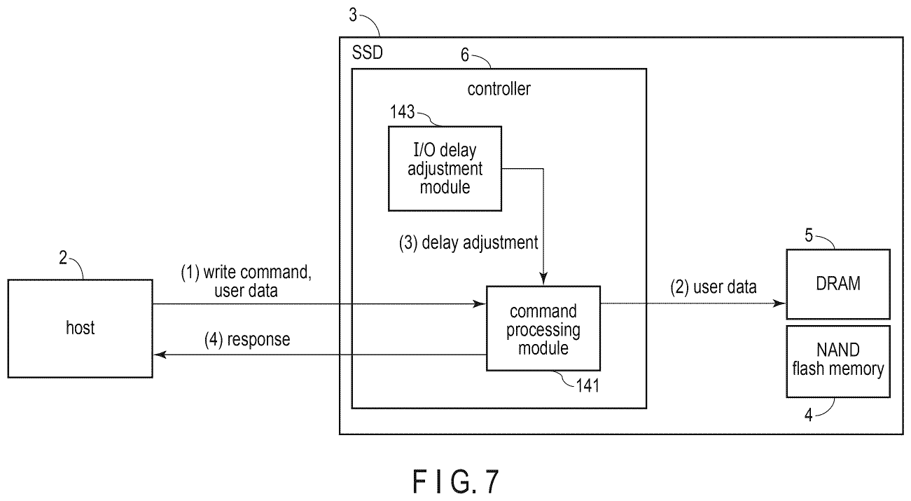

FIG. 7 illustrates an example of a write operation using the fast path 85 in the SSD 3.

First, the command processing module 141 of the SSD 3 receives, from the host 2, a write command and user data to be written in accordance with the write command ((1) in FIG. 7). The command processing module 141 transfers (stores) the received user data to the DRAM 5 ((2) in FIG. 7). For example, the command processing module 141 may manage a logical address designated in the write command and a memory location in the DRAM 5 where the user data has been stored in association with each other.

The I/O delay adjustment module 143 adjusts a timing at which the command processing module 141 executes the write completion process, based on the delay ((3) in FIG. 7). In a case where the target performance of the SSD 3 is equal to or lower than the maximum performance of the fast path, for example, a value of zero or larger is set as the delay. In other words, in a case where the target performance of the SSD 3 is equal to or lower than the maximum performance of the fast path, the I/O delay adjustment module 143 adjusts the timing at which the command processing module 141 executes the write completion process. On the other hand, in a case where the target performance of the SSD 3 exceeds the maximum performance of the fast path, for example, zero is set as the delay. In other words, in a case where the target performance value of the SSD 3 exceeds the maximum performance of the fast path, the I/O delay adjustment module 143 does not adjust the timing at which the command processing module 141 executes the write completion process.

The command processing module 141 executes the write completion process according to the adjustment based on the delay by the I/O delay adjustment module 143 ((4) in FIG. 7). Specifically, in a case where the target performance of the SSD 3 is equal to or lower than the maximum performance of the fast path, the command processing module 141 generates a response to the write command when the delay has elapsed since the storage of the user data into the DRAM 5 was completed. In a case where the target performance of the SSD 3 exceeds the maximum performance of the fast path, the command processing module 141 generates the response to the write command when the storage of the user data into the DRAM 5 has been completed. Then, the command processing module 141 transmits the generated response to the host 2.

Through the write operation described above, the command processing module 141 stores, into the DRAM 5, the user data to be written in accordance with the write command. Then, in a case where the target performance of the SSD 3 is equal to or lower than the maximum performance of the fast path, the I/O delay adjustment module 143 and the command processing module 141 transmit the response to the write command to the host 2 with the delay. As a result, in a case where the target performance of the SSD 3 is equal to or lower than the maximum performance of the fast path, the target performance is realized as the actual performance of the SSD 3.

Note that, in a case where the target performance of the SSD 3 exceeds the maximum performance of the fast path, the I/O delay adjustment module 143 and the command processing module 141 transmit the response to the write command to the host 2 without delay. In this case, the target performance is not realized as the actual performance of the SSD 3.

In addition, the user data stored in the DRAM 5 in accordance with the write command is written into the NAND flash memory 4 at a certain timing. The certain timing is, for example, a timing at which the processing amount in the SSD 3 decreases (for example, idle time).

Next, a method of realizing various target performance values set for the SSD 3 will be specifically described. Hereinafter, a case where a target value of each of latency performance, tail latency performance, IOPS performance, and bandwidth performance, is set for the SSD 3 will be described.

In a case where a target value Z of the latency performance is set, a delay for realizing the target value Z of the latency performance is calculated. Specifically, in a case where a measured value z0 indicative of an actual maximum latency performance is acquired, and the measured value z0 is equal to or smaller than the target value Z, ΔZ=Z−z0 is calculated as the delay. The target value Z and the measured value z0 are, for example, values in microseconds. For example, the I/O delay adjustment module 143 performs control so that a response to a command is transmitted with the delay ΔZ, thereby realizing the target value Z of the latency performance. That is, since the I/O delay adjustment module 143 inserts the delay ΔZ into the response time, the command processing module 141 responds to the command with the target value Z.

Note that in a case where the measured value z0 exceeds the target value Z, the latency performance is non-adjustable. In this case, for example, zero is calculated as the delay, and the latency remains at the measured value z0.

In a case where a target value Y of the tail latency performance of P % is set, a delay for realizing the target value Y of the tail latency performance of P % is calculated. Specifically, in a case where a measured value y0 indicative of an actual tail latency performance of P % is acquired and the measured value y0 is equal to or smaller than the target value Y, for example, the delay is calculated so that a response time for a command selected at a frequency of ΔP=100% −P % becomes the target value Y. In a case where a measured value Y0 indicative of an actual latency performance of the command selected at the frequency of ΔP % is acquired, ΔY=Y−Y0 is calculated as the delay. The target value Y, the measured value y0, and the measured value Y0 are, for example, values in milliseconds. The I/O delay adjustment module 143 performs control so that a response to the command selected at the frequency of ΔP % is transmitted with the delay ΔY, thereby realizing the target value Y of the tail latency performance. That is, since the I/O delay adjustment module 143 inserts the delay ΔY into the response time for the command selected at the frequency of ΔP %, the command processing module 141 intentionally responds to the command of ΔP % with a response time Y.

In a case where a target value X of the IOPS performance is set, traffic of the SSD 3 in a unit time is measured, and traffic control is performed every unit time so that average IOPS performance becomes the target value X. The target value X is, for example, a value in the number of input/output operations per second. The unit time is, for example, one second. Specifically, for example, in a case where a measured value A0 indicative of an actual IOPS performance in a period from zero to one second is acquired, an IOPS performance A1 in a period from one to two seconds is controlled according to the following equation so that average IOPS performance in a period from zero to two seconds realizes the target value X.

$$( A \text{?} + A 1 ) / 2 = X$$

$$A 1 = 2 X - A \text{?}$$

Therefore, the IOPS performance A1 in the period from one to two seconds is controlled to be (2X−A0).

Note that, in the SSD 3, in a case where the target value X of the IOPS performance is lower than the maximum IOPS performance of the SSD 3, the actual IOPS performance is configurable (adjustable).

In a case where a target value W of the bandwidth performance is set, the traffic of the SSD 3 in a unit time is measured, and the traffic control is performed every unit time so that average bandwidth performance becomes the target value W. The target value W is, for example, a value in byte per second. Specifically, for example, in a case where a measured value C0 indicative of an actual bandwidth performance in a period from zero to one second is acquired, a bandwidth performance C1 in a period from one to two seconds is controlled according to the following equation so that average bandwidth performance in a period from zero to two seconds realizes the target value W.

$$( C \text{?} + C 1 ) / 2 = W$$

$$C 1 = 2 W - C \text{?}$$

Therefore, the bandwidth performance C1 in the period from one to two seconds is controlled to be (2W−C0).

Note that, in the SSD 3, in a case where the target value W of the bandwidth performance is lower than the maximum bandwidth performance of the SSD 3, the actual bandwidth performance is configurable (adjustable).

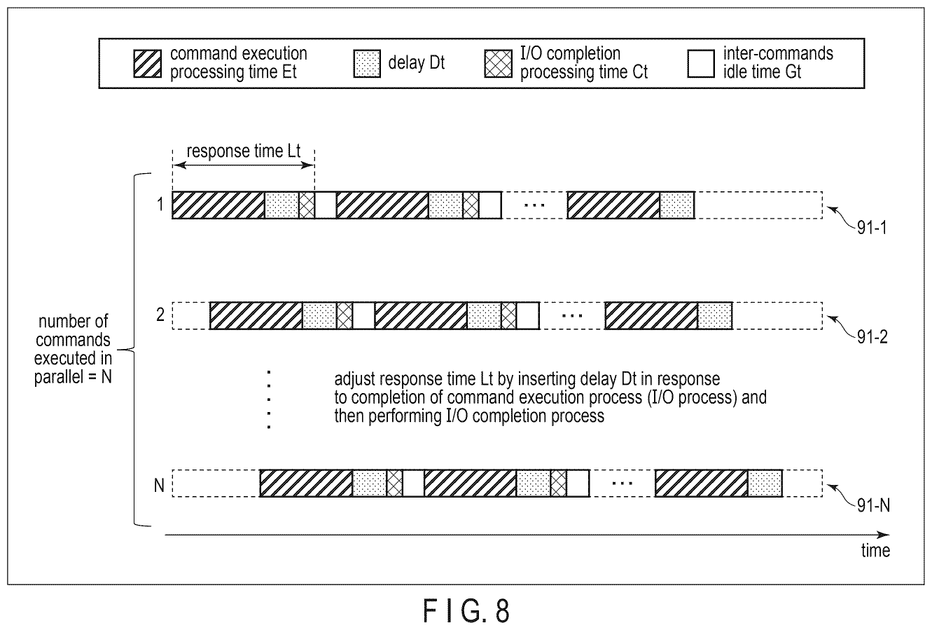

With reference to FIG. 8, a method for realizing the target value of the IOPS performance and the target value of the bandwidth performance will be further described. In a case where at least one of the target value of the IOPS performance and the target value of the bandwidth performance is set, the target value is realized by inserting, into the response time, a delay that is calculated according to an equation that describes the relationship between the delay, and the IOPS performance and the bandwidth performance. Note that, for example, the IOPS can be calculated from the bandwidth, and vice versa.

FIG. 8 illustrates an example of response times (latencies) for commands in the SSD 3. Here, it is assumed that N commands are executed in parallel. In the SSD 3, N processing units 91-1, 91-2, . . . , and 91-N, each of which processes commands, may operate in parallel. N is an integer of one or larger.

A response time Lt for a command includes a command execution processing time Et, a delay Dt, and an I/O completion processing time Ct that correspond to the command. The command execution processing time Et is a time required for the command execution process. The delay Dt is a time for delaying a response to the command. The I/O completion processing time Ct is a time required for the I/O completion process.

In a processing unit, an inter-commands idle time Gt is provided between the response time Lt for a command and the issuance of the next command. The inter-commands idle time Gt is, for example, a time interval between transmission of a response to the command and reception of the next command.

In the example illustrated in FIG. 8, the response time Lt is adjusted by inserting the delay Dt in a state where the command execution process is completed and then executing the I/O completion process. That is, the response time Lt is adjusted by transitioning to the I/O completion processing time Ct in accordance with the elapse of the delay Dt from the end of the command execution processing time Et.

By using the command execution processing time Et, the delay Dt, the I/O completion processing time Ct, and the inter-commands idle time Gt, the response time Lt and the IOPS are expressed by the following equations.

$$Response time Lt [ sec . ] = Et + Dt + Ct$$

$$IOPS per processing unit = 1 / ( Et + Dt + Ct + Gt )$$

IOPS_N that represent IOPS in a case where N commands are executed in parallel are expressed by the following equation, that is,
IOPS_N=N/(Et+Dt+Ct+Gt)=N/(T+Dt)=(N/T)/(1 +Dt/T), in which T=Et+Ct+Gt
   Further, by letting a ratio of Dt to T be defined as τ (i.e., Dt/T=τ), the following equation is derived.

$$IOPS\_N = ( N / T ) / ( 1 + τ ) \qquad Equation ( 1 )$$

According to Equation (1), as τ(=Dt/T) increases, the IOPS_N decrease. That is, the IOPS_N decrease as the ratio of the delay Dt to the total time T of the command execution processing time Et, the I/O completion processing time Ct, and the inter-commands idle time Gt increases. In addition, an influence that the IOPS_N decrease according to the increase in τ increases as the number N of commands executed in parallel increases.

Next, it is indicated that a delay Dt for realizing certain IOPS_N is derived by calculation. Hereinafter, Equation (1) is transformed and solved for Dt.

$$Equation ( 2 )$$

$$IOPS\_N = ( N / T ) / ( 1 + τ ) ⇔ IOPS\_N \cdot ( 1 + τ ) = N / T ⇔ ( 1 + τ ) = ( N / T ) / IOPS\_N ⇔ τ = ( N / T ) / IOPS\_N - 1 ⇔ Dt / T = ( N / T ) / IOPS\_N - 1 ⇔ Dt = N / IOPS\_N - T$$

As shown in Equation (2), the delay Dt for realizing the certain IOPS_N is calculated from the number N of commands executed in parallel and the total time T of the command execution processing time Et, the I/O completion processing time Ct, and the inter-commands idle time Gt. That is, according to Equation (2), the delay Dt for realizing the target value X of the IOPS performance is calculated from the number N of commands executed in parallel and the total time T. For example, the I/O delay adjustment module 143 performs control so that a response to a command is transmitted with the delay Dt, thereby realizing the target value X of the IOPS performance.

The bandwidth is calculable from the IOPS. A bandwidth B_S [byte/sec.] in a case where the size of data input/output for each command is S bytes is expressed by the following equation.

$$B\_S = S \cdot IOPS\_N = ( SN / T ) / ( 1 + τ ) \qquad Equation ( 3 )$$

Equation (3) is transformed and solved for Dt.

$$Dt = SN / B\_S - T \qquad Equation ( 4 )$$

For example, the I/O delay adjustment module 143 performs control so that a response to a command is transmitted with the delay Dt according to Equation (4), thereby realizing the target value W of the bandwidth performance.

Note that in a case where the target performance value of the IOPS (or the target performance value of the bandwidth) is set, the delay ΔZ=Z−z0 for latency performance Z is as follows.

$$Δ Z = Dt = N / IOPS\_N - T$$

Thus, the latency performance Z that is based on the delay Dt calculated by using the target performance value of the IOPS is realized.

As described above, in the SSD 3, the target values of various performance indicators set for the SSD 3 may be realized by inserting the calculated delay into the response time.

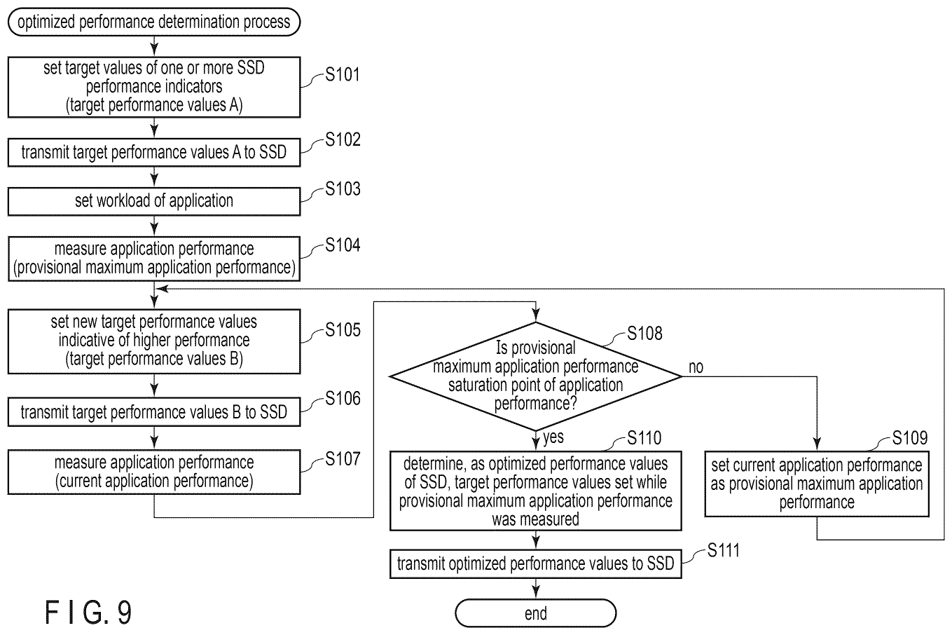

Next, processes executed in the host 2 will be described with reference to FIGS. 9 to 11.

FIG. 9 is a flowchart illustrating an example of the procedure of an optimized performance determination process executed in the host 2. The optimized performance determination process is a process for determining the performance of the SSD 3 optimized for the application in the host 2 (i.e., determining optimized performance values). The CPU 21 of the host 2 executes the optimized performance determination process when executing an application process, for example.

Here, as an example, a case where access to the SSD 3 in the application process is performed with a constant workload, and the target values of the one or more SSD performance indicators are gradually changed from values indicative of low performance to values indicative of high performance will be explained. The workload is, for example, a sufficiently high workload (for example, the maximum possible workload) among workloads assumed to be required in the application.

First, the CPU 21 sets target values of the one or more SSD performance indicators (target performance values A), respectively (step S101). Specifically, for example, the CPU 21 sets values indicative of low performance estimated to be insufficient for the application as the target performance values A. The CPU 21 transmits the set target performance values A to the SSD 3 (step S102).

In addition, the CPU 21 sets a workload of the application (step S103). As a result, access according to the set workload is requested to the SSD 3.

The CPU 21 measures the application performance while the target performance values A are set, as a provisional maximum application performance (step S104). That is, the CPU 21 measures the application performance while the process according to the set target performance values A and the set workload is executed in the SSD 3.

Next, the CPU 21 sets new target performance values of the one or more SSD performance indicators (target performance values B), respectively, that indicate performance higher than that of the target performance values A (step S105). Specifically, for example, the CPU 21 changes a certain target performance value to a value indicative of high performance by a value that is defined for the corresponding SSD performance indicator. The CPU 21 transmits the set target performance values B to the SSD 3 (step S106).

The CPU 21 measures the application performance while the target performance values B are set, as the current application performance (step S107). That is, the CPU 21 measures the application performance while a process according to the set target performance values B and the set workload is executed in the SSD 3. Then, the CPU 21 determines whether or not the provisional maximum application performance is the saturation point of the application performance (step S108). Specifically, for example, the CPU 21 determines whether or not the current application performance is equal to or lower than the provisional maximum application performance. The current application performance being equal to or lower than the provisional maximum application performance indicates that the application performance is not improved although the target performance values of the SSD 3 are changed to the values indicative of higher performance. For example, based on the current application performance being equal to or lower than the provisional maximum application performance, the CPU 21 determines that the provisional maximum application performance is the saturation point of the application performance.

In a case where the provisional maximum application performance is not the saturation point of the application performance (no in step S108), the CPU 21 sets the current application performance as the provisional maximum application performance (step S109). Then, the process executed by the CPU 21 returns to step S105. That is, the CPU 21 further performs a process of setting new target performance values and measuring the application performance while a process according to the new target performance values and the workload is executed in the SSD 3.

In a case where the provisional maximum application performance is the saturation point of the application performance (yes in step S108), the CPU 21 determines the target performance values set when the provisional maximum application performance was measured, as the optimized performance values of the SSD 3 (step S110). Then, the CPU 21 transmits the optimized performance values to the SSD 3 (step S111), and ends the optimized performance determination process.

Through the optimized performance determination process described above, the CPU 21 can determine the optimized performance values of the SSD 3. Specifically, the CPU 21 repeatedly performs the setting of the target performance values and the measurement of the application performance while a process according to the set target performance values and the set workload is executed in the SSD 3, thereby finding the saturation point of the application performance. Then, the CPU 21 determines the performance values of the SSD 3 that correspond to the saturation point of the application performance, as the optimized performance values of the SSD 3.

Note that the CPU 21 may execute the optimized performance determination process while changing the workload to various access patterns that may be assumed to be required in the application. Further, in the optimized performance determination process, for example, the CPU 21 may set, as the target performance values A, values indicative of high performance estimated to be excessive for the application, and gradually change the target performance values to values indicative of lower performance.

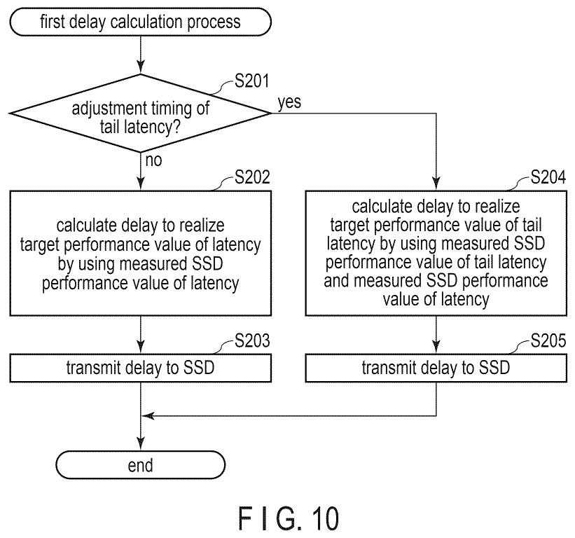

FIG. 10 is a flowchart illustrating an example of the procedure of a first delay calculation process executed in the host 2. The first delay calculation process is a process of calculating a delay for the SSD 3 to realize a target performance value. The delay is a time for delaying a response of the SSD 3 to a command by the host 2. The CPU 21 of the host 2 executes the first delay calculation process when a measured value (measured SSD performance value) of each of the one or more SSD performance indicators has been received from the SSD 3. Here, it is assumed that a target performance value of the latency and a target performance value of the tail latency are set.

First, the CPU 21 determines whether or not it is a timing to adjust the tail latency on the basis of the target performance value of the tail latency (step S201). For example, in a case where the target performance value of the tail latency of 99.9% is set, the CPU 21 determines whether or not it is a timing to select a command at a frequency of 0.1%. When selecting a command at the frequency of 0.1%, the CPU 21 selects one command while 1000 commands are transmitted from the host 2 to the SSD 3, for example.

In a case where it is not a timing to adjust the tail latency (no in step S201), that is, in a case where it is a timing to adjust the latency, the CPU 21 calculates a delay for realizing the target performance value of the latency by using the measured SSD performance value of the latency (step S202). Specifically, the CPU 21 calculates, as the delay, a value obtained by subtracting the measured SSD performance value of the latency from the target performance value of the latency. Note that, in a case where the measured SSD performance value of the latency is larger than the target performance value of the latency, it is impossible to realize the target performance value of the latency. In this case, the CPU 21 calculates zero as the delay, for example. The CPU 21 transmits the calculated delay to the SSD 3 (step S203), and ends the first delay calculation process.

In a case where it is a timing to adjust the tail latency (yes in step S201), the CPU 21 calculates a delay for realizing the target performance value of the tail latency by using the measured SSD performance value of the tail latency and the measured SSD performance value of the latency (step S204). Specifically, in a case where the measured SSD performance value of the tail latency is smaller than the target performance value of the tail latency, the CPU 21 calculates, as the delay, a value obtained by subtracting the measured SSD performance value of the latency from the target performance value of the tail latency. Note that, in a case where the measured SSD performance value of the tail latency is equal to or larger than the target performance value of the tail latency, or in a case where the measured SSD performance value of the latency is larger than the target performance value of the tail latency, the CPU 21 calculates zero as the delay, for example. The CPU 21 transmits the calculated delay to the SSD 3 (step S205), and ends the first delay calculation process.

Through the first delay calculation process described above, the CPU 21 may calculate either the delay for realizing the target performance value of the latency or the delay for realizing the target performance value of the tail latency. As a result, in the SSD 3, a response to a command is transmitted with the calculated delay, and thus the target performance value of the latency or the target performance value of the tail latency may be realized.

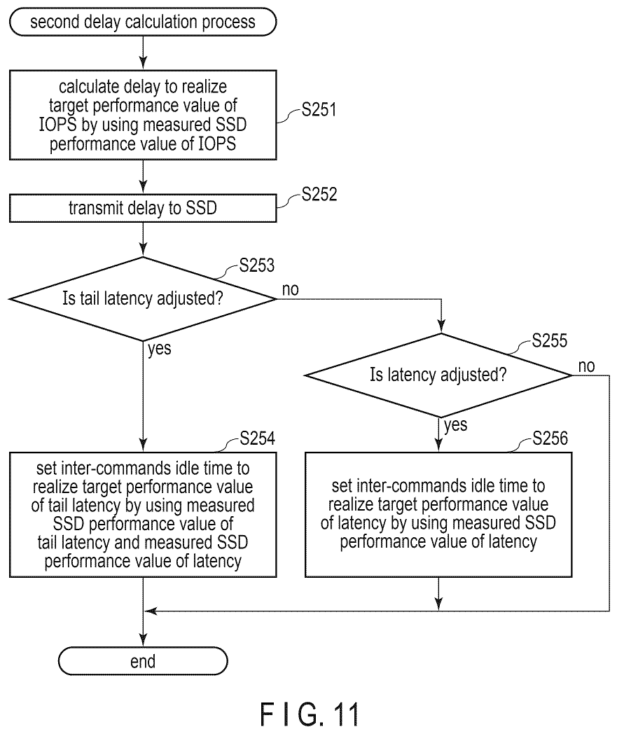

FIG. 11 is a flowchart illustrating an example of the procedure of a second delay calculation process executed in the host 2. The second delay calculation process is a process of calculating a delay for the SSD 3 to realize a target performance value. The CPU 21 of the host 2 executes the second delay calculation process when measured SSD performance values have been received from the SSD 3. Here, a case where a target performance value of the IOPS (or the bandwidth) is set and target performance values of the latency and the tail latency can be set will be explained.

The CPU 21 calculates a delay for realizing the target performance value of the IOPS by using the measured SSD performance value of the IOPS that has been received (step S251). Specifically, the CPU 21 calculates the delay for realizing the target performance value of the IOPS by an operation according to Equation (2) described above. The CPU 21 transmits the calculated delay to the SSD 3 (step S252).

Next, the CPU 21 determines whether or not to adjust the tail latency (step S253). Specifically, the CPU 21 determines whether or not the target performance value of the tail latency is set and it is a timing to adjust the tail latency.

In the case of adjusting the tail latency (yes in step S253), the CPU 21 set an inter-commands idle time for realizing the target performance value of the tail latency by using the measured SSD performance value of the tail latency and the measured SSD performance value of the latency (step S254), and ends the second delay calculation process. Specifically, for example, in a case where the measured SSD performance value of the tail latency is equal to or smaller than the target performance value of the tail latency, the CPU 21 acquires (calculates), as the inter-commands idle time, a time obtained by subtracting the measured SSD performance value of the latency from the target performance value of the tail latency.

In the case of not adjusting the tail latency (no in step S253), the CPU 21 determines whether or not to adjust the latency (step S255). Specifically, the CPU 21 determines whether or not the target performance value of the latency is set.

In the case of adjusting the latency (yes in step S255), the CPU 21 sets an inter-commands idle time for realizing the target performance value of the latency by using the measured SSD performance value of the latency (step S256), and ends the second delay calculation process. Specifically, for example, in a case where the measured SSD performance value of the latency is equal to or smaller than the target performance value of the latency, the CPU 21 acquires, as the inter-commands idle time, a time obtained by subtracting the measured SSD performance value of the latency from the target performance value of the latency.

In the case of not adjusting the latency (no in step S255), the CPU 21 ends the second delay calculation process.

Through the second delay calculation process described above, the CPU 21 can calculate the delay for realizing the target performance value of the IOPS (or the bandwidth). As a result, in the SSD 3, a response to a command is transmitted with the calculated delay, and thus the target performance value of the IOPS is realized.

In addition, in a case where the inter-commands idle time for realizing the target performance value of the tail latency is set, the CPU 21 is controlled to wait for the set inter-commands idle time since a response to a command was received from the SSD 3, and then issue the next command. As a result, the CPU 21 can realize the target performance value of the tail latency. The same applies to the target performance value of the latency.

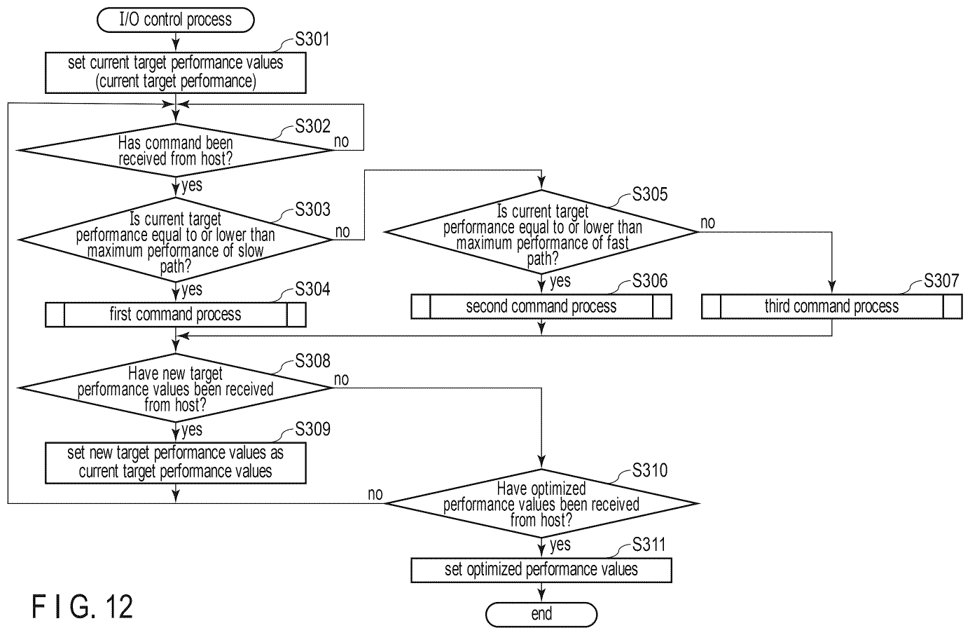

Processes executed in the SSD 3 will be described with reference to FIGS. 12 to 15. Here, a case where a command received from the host 2 is either a read command or a write command will be described.

FIG. 12 is a flowchart illustrating an example of the procedure of an I/O control process executed in the SSD 3. The I/O control process is a process of controlling an operation in accordance with a command on the basis of target performance values of the SSD 3. For example, the CPU 14 of the SSD 3 executes the I/O control process when having received the target performance values from the host 2.

First, the CPU 14 sets the received target performance values as current target performance values (step S301). Performance based on the current target performance values may be referred to as current target performance. Then, the CPU 14 determines whether or not a command has been received from the host 2 (step S302).

In a case where a command has not been received from the host 2 (no in step S302), the process executed by the CPU 14 returns to step S302.

In a case where a command has been received from the host 2 (yes in step S302), the CPU 14 determines whether or not the current target performance is equal to or lower than the maximum performance of the slow path (step S303).

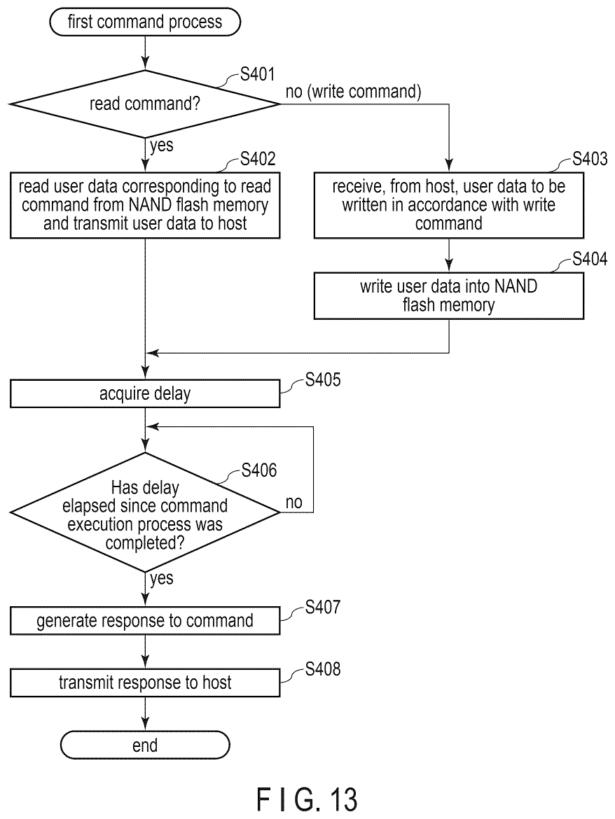

In a case where the current target performance is equal to or lower than the maximum performance of the slow path (yes in step S303), the CPU 14 executes a first command process (step S304), and the process executed by the CPU 14 proceeds to step S308. The first command process is a process of performing an operation in accordance with the received command with the slow path 81 and adjusting a delay of a response to the command. A specific procedure of the first command process is described below with reference to FIG. 13.

In a case where the current target performance exceeds the maximum performance of the slow path (no in step S303), the CPU 14 determines whether or not the current target performance is equal to or lower than the maximum performance of the fast path (step S305).

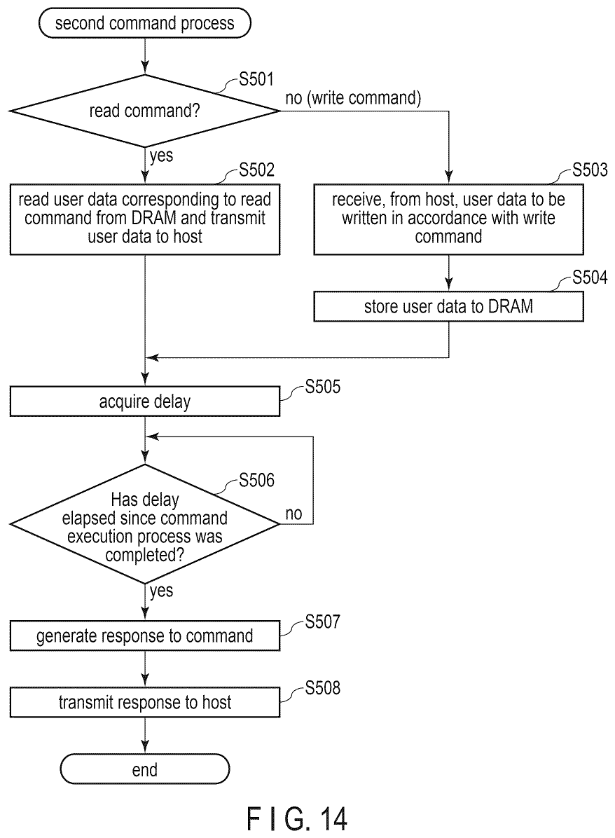

In a case where the current target performance is equal to or lower than the maximum performance of the fast path (yes in step S305), the CPU 14 executes a second command process (step S306), and the process executed by the CPU 14 proceeds to step S308. The second command process is a process of performing an operation in accordance with the received command with the fast path 85 and adjusting the delay of the response to the command. A specific procedure of the second command process is described below with reference to FIG. 14.

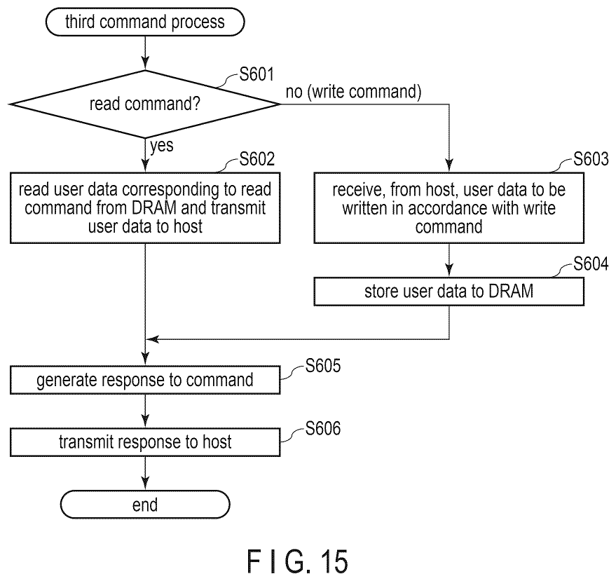

In a case where the current target performance exceeds the maximum performance of the fast path (no in step S305), the CPU 14 executes a third command process (step S306), and the process executed by the CPU 14 proceeds to step S308. The third command process is a process of performing an operation in accordance with the received command with the fast path 85. In the third command process, the delay of the response to the command is not adjusted. A specific procedure of the third command process is described below with reference to FIG. 15.

Next, the CPU 14 determines whether or not new target performance values have been received from the host 2 (step S308).

In a case where the new target performance values have been received from the host 2 (yes in step S308), the CPU 14 sets the received new target performance values as the current target performance values (step S309). Then, the process executed by the CPU 14 returns to step S302. That is, the CPU 14 further executes a process in accordance with a subsequent command on the basis of the new target performance values.

In a case where the new target performance values have not been received from the host 2 (no in step S308), the CPU 14 determines whether or not the optimized performance values of the SSD 3 have been received from the host 2 (step S310). The optimized performance values of the SSD 3 respectively indicate values of the one or more SSD performance indicators that are optimized for the application in the host 2.

In a case where the optimized performance values have not been received from the host 2 (no in step S310), the process executed by the CPU 14 returns to step S302.

In a case where the optimized performance values have been received from the host 2 (yes in step S310), the CPU 14 sets the received optimized performance values (step S311). That is, the CPU 14 sets the SSD 3 to operate with the optimized performance values. Then, the CPU 14 ends the I/O control process. Note that, in the SSD 3 in which the optimized performance values are set, the CPU 14 may execute the process from step S302 to step S307.

Through the I/O control process described above, the CPU 14 controls the operation in accordance with the command received from the host 2, based on the set target performance values of the SSD 3. Specifically, in a case where the target performance is equal to or lower than the maximum performance of the slow path and in a case where the target performance is equal to or lower than the maximum performance of the fast path, the CPU 14 adjusts the delay of the response to the command, thereby controlling the SSD 3 to operate with the target performance. That is, the CPU 14 performs control so that the SSD 3 does not operate with excessive performance that exceeds the target performance. As a result, the CPU 14 can reduce the power consumption of the SSD 3 according to the target performance values, thereby improving the energy efficiency.

FIG. 13 is a flowchart illustrating an example of the procedure of the first command process executed in the SSD 3. The first command process is a process of performing the command execution process in accordance with a command, which has been received from the host 2, with the slow path 81 and adjusting a delay of a response to the command. The first command process corresponds to step S304 of the I/O control process described above with reference to FIG. 12.

First, the CPU 14 determines whether or not the command received from the host 2 is a read command (step S401). That is, the CPU 14 determines whether the command is a read command or a write command.

In a case where the received command is a read command (yes in step S401), the CPU 14 reads user data corresponding to the read command from the NAND flash memory 4 and transmits the user data to the host 2 (step S402). Then, the process executed by the CPU 14 proceeds to step S405.

In a case where the received command is a write command (no in step S401), the CPU 14 receives, from the host 2, user data to be written in accordance with the write command (step S403). The CPU 14 writes the received user data into the NAND flash memory 4 (step S404). For example, the CPU 14 updates the logical-to-physical address translation table 52 to associate a logical address designated in the write command with a physical address indicative of a physical memory location where the user data has been written. Then, the process executed by the CPU 14 proceeds to step S405.

Next, the CPU 14 acquires a delay that is a time for which the response to the command is to be delayed (step S405). The delay is received from the host 2, for example. The CPU 14 determines whether or not the delay has elapsed since the command execution process was completed (step S406).

In a case where the delay has not yet elapsed since the command execution process was completed (no in step S406), the process executed by the CPU 14 returns to step S406. That is, the CPU 14 waits until the delay elapses since the command execution process was completed.

In a case where the delay has elapsed since the command execution process was completed (yes in step S406), the CPU 14 generates the response to the command (step S407). That is, the CPU 14 starts the generation of the response to the command not immediately after the completion of the command execution process but with the delay. Then, the CPU 14 transmits the generated response to the host 2 (step S408), and ends the first command process.

Through the first command process described above, the CPU 14 performs the command execution process on the NAND flash memory 4, and transmits the response to the host 2 when the delay has elapsed since the command execution process was completed. Therefore, in a case where the target performance of the SSD 3 is equal to or lower than the maximum performance of the slow path, the CPU 14 can delay the transmission of the response to the host 2 by inserting the delay after the completion of the command execution process. As a result, the target performance is realized in the SSD 3.

FIG. 14 is a flowchart illustrating an example of the procedure of the second command process executed in the SSD 3. The second command process is a process of executing the command execution process in accordance with a command, which has been received from the host 2, with the fast path 85 and adjusting a delay of a response to the command. The second command process corresponds to step S306 of the I/O control process described above with reference to FIG. 12.

First, the CPU 14 determines whether or not the command received from the host 2 is a read command (step S501).

In a case where the received command is a read command (yes in step S501), the CPU 14 reads user data corresponding to the read command from the DRAM 5 and transmits the user data to the host 2 (step S502). For example, the user data to be read in accordance with the read command has been read in advance from the NAND flash memory 4 and has been stored (cached) in the data buffer 53 in the DRAM 5. Then, the process executed by the CPU 14 proceeds to step S505.

In a case where the received command is a write command (no in step S501), the CPU 14 receives, from the host 2, user data to be written in accordance with the write command (step S503). The CPU 14 stores the received user data in the DRAM 5 (step S504). The stored user data is written into the NAND flash memory 4 at a certain timing (for example, a timing at which the processing amount in the SSD 3 decreases). Then, the process executed by the CPU 14 proceeds to step S505.

The subsequent process from step S505 to step S508 is similar to the process from step S405 to step S408 described above with reference to FIG. 13.

Through the second command process described above, the CPU 14 performs the command execution process on the DRAM 5, and transmits the response to the host 2 when the delay has elapsed since the command execution process was completed. Therefore, in a case where the target performance of the SSD 3 is equal to or lower than the maximum performance of the fast path, the CPU 14 can delay the transmission of the response to the host 2 by inserting the delay after the completion of the command execution process. As a result, the target performance is realized in the SSD 3.

FIG. 15 is a flowchart illustrating an example of the procedure of the third command process executed in the SSD 3. The third command process is a process of performing the command execution process in accordance with a command, which has been received from the host 2, with the fast path 85. The third command process corresponds to step S307 of the I/O control process described above with reference to FIG. 12.

In the third command process, a response to the command is not delayed. Specifically, a process from step S601 to step S606 of the third command process corresponds to a process in which step S505 and step S506 for delaying the response are excluded from the second command process described above with reference to FIG. 14.

Therefore, through the third command process, the CPU 14 performs the command execution process on the DRAM 5, and transmits the response to the host 2 when the command execution process has been completed. Therefore, in a case where the target performance of the SSD 3 exceeds the maximum performance of the fast path, the CPU 14 can transmit the response to the host 2 without delay after the completion of the command execution process.

### Modification

FIG. 16 illustrates another example of the performance control operation in the SSD 3 and the host 2. In the example of the performance control operation described above with reference to FIG. 3, a case where the target performance (target performance values) and the delay are determined in the host 2 has been described. By contrast, in the example of the performance control operation illustrated in FIG. 16, the target performance and the delay are determined in the SSD 3. In this case, the CPU 14 of the SSD 3 further functions as, for example, the performance control module 144.

First, the performance control module 144 of the SSD 3 sends one or more target performance values that correspond to the one or more SSD performance indicators, respectively (target performance values A), to the command processing module 141 ((1) in FIG. 16). Specifically, the performance control module 144 determines, for example, the target performance values A estimated to be insufficient for the application in the host 2. Alternatively, the performance control module 144 may determine the target performance values A estimated to be excessive for the application in the host 2. The performance control module 144 sends the determined target performance values A to the command processing module 141. The performance control module 144 may further transmit the target performance values A to the host 2.

The command processing module 141 sets the target performance values A received from the performance control module 144 as the current target performance values in the SSD 3. Note that the performance control module 144 may notify the command processing module 141 of the target performance values A by setting the target performance values A as the current target performance values.

Next, the command issuing module 211 of the host 2 issues a command to the SSD 3 according to a workload of the application in the host 2 ((2) in FIG. 16).

The command processing module 141 of the SSD 3 executes the command execution process on the basis of the issued command and the current target performance values. Specifically, in a case where performance based on the current target performance values (target performance) is equal to or lower than the maximum performance of the slow path, the command processing module 141 executes the command execution process with the slow path 81. In a case where the current target performance is higher than the maximum performance of the slow path, the command processing module 141 executes the command execution process with the fast path 85.

The performance monitoring module 142 measures the one or more SSD performance indicators in a process according to one or more commands received from the host 2. As a result, the performance monitoring module 142 acquires one or more measured values (measured SSD performance values) that indicate the one or more measured SSD performance indicators, respectively. The performance monitoring module 142 sends the measured SSD performance values to the performance control module 144 ((3) in FIG. 16).

The performance control module 144 calculates a delay based on the measured SSD performance values received from the performance monitoring module 142 and the target performance values A. Then, the performance control module 144 sends the calculated delay to the I/O delay adjustment module 143 ((4) in FIG. 16).

The performance control module 144 may calculate an inter-commands idle time based on the measured SSD performance values and the target performance values A. The performance control module 144 transmits the calculated inter-commands idle time to the host 2 ((5) in FIG. 16). The command issuing module 211 of the host 2 may control a timing of issuing a command for the SSD 3, based on the inter-commands idle time received from the performance control module 144.

The I/O delay adjustment module 143 adjusts a timing at which the command processing module 141 executes the I/O completion process, based on the delay received from the performance control module 144 ((6) in FIG. 16). Specifically, for example, under control from the I/O delay adjustment module 143, the command processing module 141 starts the I/O completion process when the delay has elapsed since the command execution process was completed.

The command processing module 141 executes the I/O completion process according to the adjustment of the delay by the I/O delay adjustment module 143. That is, when the delay has elapsed since the command execution process was completed, the command processing module 141 generates the response to the command and transmits the response to the host 2 ((7) in FIG. 16).

The response processing module 212 of the host 2 executes a process according to the response received from the SSD 3.

Further, the performance monitoring module 213 measures the host performance indicator while target performance based on certain target performance values (for example, the target performance values A) is set. As a result, the performance monitoring module 213 acquires a measured value indicative of the measured host performance indicator (i.e., measured application performance value). The performance monitoring module 213 transmits the measured application performance value to the SSD 3 ((8) in FIG. 16).

When having received the measured application performance value from the host 2, the performance control module 144 of the SSD 3 sends one or more new target performance values that correspond to the one or more SSD performance indicators, respectively (target performance values B), to the command processing module 141 ((9) in FIG. 16). Specifically, the performance control module 144 determines, for example, the target performance values B that indicate performance higher than that of the target performance values A. Alternatively, the performance control module 144 may determine the target performance values B that indicate performance lower than that of the target performance values A. The performance control module 144 sends the determined target performance values B to the command processing module 141. As a result, the SSD 3 and the host 2 perform an operation for the target performance values B that is similar to the above-described operation in a case where the target performance values A are set.

In addition, the performance control module 144 detects the saturation point of the measured application performance value by using a plurality of measured application performance values received from the host 2. The performance control module 144 determines target performance values that correspond to the detected saturation point of the measured application performance value, as the optimized performance values of the SSD 3. The performance control module 144 sends, for example, the determined optimized performance values to the command processing module 141 ((10) in FIG. 16). In the SSD 3, the optimized performance values may be set as the current target performance values, and an operation based on the optimized performance values may be performed.

A specific method of determining the optimized performance values by the performance control module 144 is similar to the method of determining the optimized performance values by the performance control module 214 of the host 2 described above with reference to FIG. 3.

Through the performance control operation described above, the SSD 3 determines the delay based on the target performance and the measured SSD performance values. The SSD 3 transmits the response to the command with the determined delay. As a result, the SSD 3 can control its performance to realize the target performance. In addition, the SSD 3 can detect the saturation point of the measured application performance value by using the measured application performance values while the target performances are respectively set, and determine the optimized performance values of the SSD 3.

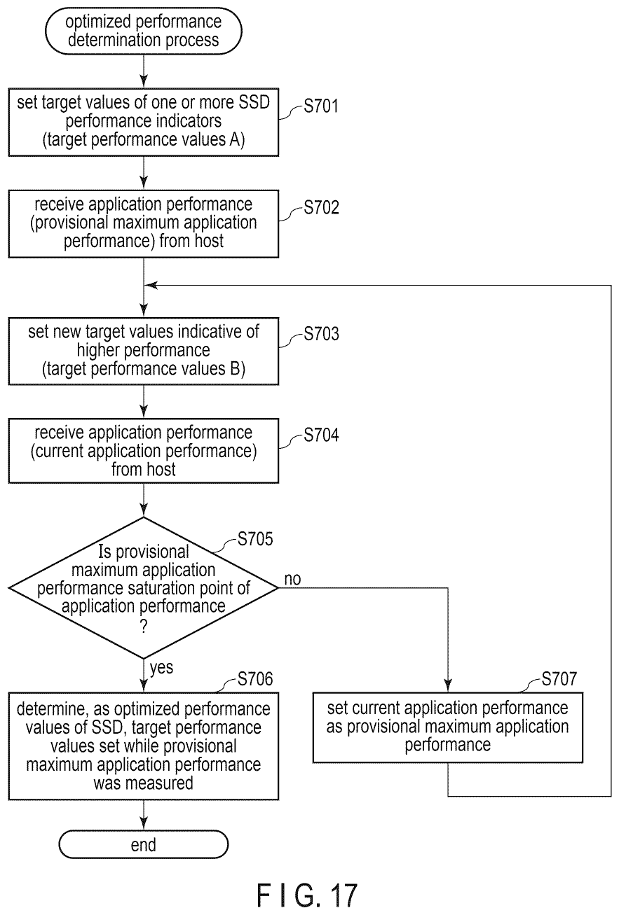

FIG. 17 is a flowchart illustrating an example of the procedure of an optimized performance determination process executed in the SSD 3. As described above, the optimized performance determination process is a process for determining the SSD performance optimized for the application in the host 2 (determining optimized performance values). The CPU 14 of the SSD 3 executes the optimized performance determination process, for example, when an application process is executed in the host 2. Here, as an example, a case where access to the SSD 3 in the application process is performed in a constant workload, and the target values of the one or more SSD performance indicators are gradually changed from values indicative of low performance to values indicative of high performance will be explained.

First, the CPU 14 sets target values of the one or more SSD performance indicators (target performance values A), respectively (step S701). Specifically, for example, the CPU 14 sets values indicative of low performance estimated to be insufficient for the application in the host 2 as the target performance values A. Then, the CPU 14 receives, from the host 2, the application performance while the target performance values A are set, as the provisional maximum application performance (step S702). That is, the CPU 14 receives, from the host 2, the application performance measured while a process according to the set target performance values A and the workload is executed in the SSD 3.

Next, the CPU 21 sets new target performance values of the one or more SSD performance indicators (target performance values B), respectively, that indicate performance higher than that of the target performance values A (step S703). Specifically, for example, the CPU 14 changes a certain target performance value to a value indicative of high performance by a value that is defined for the corresponding SSD performance indicator. The CPU 14 receives, from the host 2, the application performance while the target performance values B are set, as the current application performance (step S704). Then, the CPU 14 determines whether or not the provisional maximum application performance is the saturation point of the application performance (step S705). For example, based on the current application performance being equal to or lower than the provisional maximum application performance, the CPU 14 determines that the provisional maximum application performance is the saturation point of the application performance.

In a case where the provisional maximum application performance is not the saturation point of the application performance (no in step S705), the CPU 14 sets the current application performance as the provisional maximum application performance (step S707). Then, the process executed by the CPU 14 returns to step S703. That is, the CPU 14 further performs a process of setting new target performance values and acquiring the application performance while the new target performance values are set.

In a case where the provisional maximum application performance is the saturation point of the application performance (yes in step S705), the CPU 14 determines the target performance values set when the provisional maximum application performance was acquired, as the optimized performance values of the SSD 3 (step S706), and ends the optimized performance determination process.

Through the optimized performance determination process described above, the CPU 14 can determine the optimized performance values of the SSD 3. Specifically, the CPU 14 repeatedly performs the setting of the target performance values and the acquisition of the application performance while the target performance values are set, thereby finding the saturation point of the application performance. Then, the CPU 14 determines the performance values of the SSD 3 corresponding to the saturation point of the application performance, as the optimized performance values of the SSD 3.

Note that in the optimized performance determination process, for example, the CPU 14 may set, as the target performance values A, values indicative of high performance estimated to be excessive for the application, and gradually change the target performance values to values indicative of lower performance.

In addition, a process in a case where the CPU 14 of the SSD 3 calculates the delay corresponds to, for example, a process in which steps S203 and S205 of transmitting the delay to the SSD 3 are excluded from the first delay calculation process, which is described above with reference to FIG. 10. Alternatively, the process in a case where the CPU 14 of the SSD 3 calculates the delay corresponds to, for example, a process in which step S252 of transmitting the delay to the SSD 3 is excluded and steps of transmitting the inter-commands idle times calculated in steps S254 and S256 to the host 2 are added, in the second delay calculation process described above with reference to FIG. 11.

Note that a process for determining the target performance values, the delay, and the optimized performance values may be executed by the performance control module 144 of the SSD 3 and the performance control module 214 of the host 2 in cooperation with each other. That is, a part of the process may be executed in the SSD 3, and the remaining part of the process may be executed in the host 2. Therefore, the SSD 3 and the host 2 can cooperate with each other to determine the target performance values, the delay, and the optimized performance values.

As described above, according to the present embodiment, the energy efficiency can be improved.

The command processing module 141 (or the performance control module 144) sets a target value for a first indicator (SSD performance indicator) that is related to performance of the memory system 3. The performance monitoring module 142 measures the first indicator in a process performed in accordance with a first command received from the host 2 to acquire a measured value that indicates the measured first indicator. The I/O delay adjustment module 143 acquires a delay for realizing the target value, by using the measured value. The I/O delay adjustment module 143 and the command processing module 141 transmit, to the host 2, a response to a second command received from the host 2 with the delay.

With the above configuration, in the memory system 3, a response time for a command received from the host 2 is dynamically adjusted based on the delay that is used for realizing the target value of the first indicator and is calculated by using the measured value of the first indicator. This enables the memory system 3 to realize performance based on the target value. Accordingly, for example, the power consumption of the memory system 3 can be reduced by operating the memory system 3 with a certain target value. Therefore, in the memory system 3, the energy efficiency can be improved.

Each of the various functions described in the embodiment may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiment may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A memory system connectable to a host, the memory system comprising:
a nonvolatile memory; and
a controller electrically connected to the nonvolatile memory and configured to:
set a first target value for a first indicator that is related to performance of the memory system;
receive a first command from the host;
in accordance with the received first command, perform a first process;
in the first process, measure the first indicator to acquire a first measured value that indicates the measured first indicator;
acquire a delay for realizing the first target value, by using the first measured value;
receive a second command from the host; and
transmit a response to the second command, to the host with the delay.

2. The memory system according to claim 1, wherein
the controller is further configured to:
receive the first target value from the host;
set the received first target value for the first indicator;
acquire the first measured value;
transmit the first measured value to the host;
receive, from the host, the delay calculated by using the transmitted first measured value; and
transmit the response to the host with the received delay.

3. The memory system according to claim 1, wherein
the controller is further configured to:
determine the first target value;
set the determined first target value for the first indicator;
acquire the first measured value;
calculate the delay by using the first target value and the first measured value; and
transmit the response to the host with the calculated delay.

4. The memory system according to claim 1, wherein
the first indicator includes at least one of input/output operations per second (IOPS), a bandwidth, a latency, and a tail latency.

5. The memory system according to claim 1, wherein
the controller is further configured to:
set the first target value for the first indicator;
receive a second measured value from the host, the second measured value indicating a second indicator related to performance of the host while the first target value is set;
set a second target value for the first indicator;
receive a third measured value from the host, the third measured value indicating the second indicator while the second target value is set; and
determine a value of the first indicator that is optimized for the host by using the first target value, the second measured value, the second target value, and the third measured value.

6. The memory system according to claim 5, wherein
each of the second measured value and the third measured value is acquired by measuring the second indicator in a process that includes access to the memory system.

7. The memory system according to claim 5, wherein
the second indicator is transaction per second (TPS).

8. The memory system according to claim 1, wherein
the controller is configured to:
acquire the delay in a case where first performance based on the first target value is lower than second performance based on the first measured value; and
transmit, in a second process performed in accordance with the second command, the response to the host with the delay so that performance for the first indicator becomes lower than the second performance.

9. The memory system according to claim 1, further comprising
a random access memory, wherein
the controller is further configured to:
in a case where first performance is equal to or lower than second performance, perform the first process on the nonvolatile memory, the first performance being based on the first target value, the second performance being based on a value of the first indicator when the nonvolatile memory is accessed; and
in a case where the first performance is higher than the second performance, perform the first process on the random access memory.

10. The memory system according to claim 9, wherein
the controller is further configured to, in a case where the first performance is higher than third performance based on a value of the first indicator when the random access memory is accessed:
perform the first process on the random access memory; and
set the delay to zero.

11. An information processing system comprising:
a host; and
a memory system that includes a nonvolatile memory and a controller, wherein
the host is configured to:
transmit a command to the memory system; and
receive a response to the command from the memory system, and
the controller is electrically connected to the nonvolatile memory and configured to:
set a first target value for a first indicator that is related to performance of the memory system;
receive a first command from the host;
in accordance with the received first command, perform a first process;
in the first process, measure the first indicator to acquire a first measured value that indicates the measured first indicator;
acquire a delay for realizing the first target value, by using the first measured value;
receive a second command from the host; and
transmit a response to the second command, to the host with the delay.

12. The information processing system according to claim 11, wherein
the host is further configured to:
determine the first target value for the first indicator; and
transmit the determined first target value to the memory system,
the controller is further configured to:
receive the first target value from the host;
set the received first target value for the first indicator;
acquire the first measured value; and
transmit the first measured value to the host,
the host is further configured to:
receive the first measured value from the memory system;
calculate the delay by using the first target value and the received first measured value; and
transmit the calculated delay to the memory system, and
the controller is further configured to:
receive the delay from the host; and
transmit the response to the second command to the host with the received delay.

13. The information processing system according to claim 11, wherein
the controller is further configured to:
determine the first target value;
set the determined first target value for the first indicator;
acquire the first measured value;
calculate the delay by using the first target value and the first measured value; and
transmit the response to the second command to the host with the calculated delay.

14. The information processing system according to claim 11, wherein
the first indicator includes at least one of input/output operations per second (IOPS), a bandwidth, a latency, and a tail latency.

15. The information processing system according to claim 11, wherein
the host is further configured to:
set the first target value for the first indicator;
measure a second indicator related to performance of the host while the first target value is set to acquire a second measured value indicative of the measured second indicator;
determine a second target value for the first indicator;
measure the second indicator while the second target value is set to acquire a third measured value indicative of the measured second indicator; and
determine a value of the first indicator that is optimized for the host by using the first target value, the second measured value, the second target value, and the third measured value.

16. The information processing system according to claim 15, wherein
the host is configured to acquire each of the second measured value and the third measured value by measuring the second indicator in a process that includes access to the memory system.

17. The information processing system according to claim 11, wherein
the controller is further configured to:
set the first target value for the first indicator;
receive a second measured value from the host, the second measured value indicating a second indicator related to performance of the host while the first target value is set;
set a second target value for the first indicator;
receive a third measured value from the host, the third measured value indicating the second indicator while the second target value is set; and
determine a value of the first indicator that is optimized for the host by using the first target value, the second measured value, the second target value, and the third measured value.

18. The information processing system according to claim 11, wherein
the first indicator is one of a plurality of first indicators that include a latency and at least one of input/output operations per second (IOPS) and a bandwidth,
the controller is further configured to:
acquire the delay for realizing the first target value of the IOPS or the bandwidth, the delay being calculated by using the first measured value of the IOPS or the bandwidth; and
transmit the response to the second command to the host with the delay, and
the host is further configured to:
acquire a second delay for realizing the first target value of the latency, the second delay being calculated by using the first measured value of the latency;
in a case where the plurality of first indicators further include a tail latency, acquire a third delay for realizing the first target value of the tail latency, the third delay being calculated by using the first measured value of the tail latency and the first measured value of the latency; and
after receiving the response to the second command, issue a next command with the second delay or the third delay.

19. The information processing system according to claim 11, wherein
the memory system further includes a random access memory, and
the controller is further configured to:
in a case where first performance is equal to or lower than second performance, perform the first process on the nonvolatile memory, the first performance being based on the first target value, the second performance being based on a value of the first indicator when the nonvolatile memory is accessed; and
in a case where the first performance is higher than the second performance, perform the first process on the random access memory.

20. The information processing system according to claim 19, wherein
the controller is further configured to, in a case where the first performance is higher than third performance based on a value of each of the first indicator when the random access memory is accessed:
perform the first process on the random access memory; and
set the delay to zero.
